(19) United States
(12) Patent Application Publication
(10) Pub. No.: US 2025/0261826 A1
(43) Pub. Date: Aug. 21, 2025

(54) DISH WASHER

(71) Applicant: LG Electronics Inc., Seoul (KR)

(72) Inventors: Dong Jun CHOI, Seoul (KR); Yongnam KIM, Seoul (KR); Sangwoog CHO, Seoul (KR); Yeon A JO, Seoul (KR); Sung Hyun PARK, Seoul (KR); Jin Won KANG, Seoul (KR); Min Kyu OH, Seoul (KR)

(21) Appl. No.: 19/054,350

(22) Filed: Feb. 14, 2025

(30) Foreign Application Priority Data
Feb. 16, 2024 (KR) 10-2024-0022962
Feb. 16, 2024 (KR) 10-2024-0022973

(51) Int. Cl. A47L 15/42; A47L 15/00; E05B 5/02

(52) U.S. Cl. CPC A47L 15/4259; A47L 15/0049; E05B 5/003

(57) ABSTRACT

A dish washer includes a handle configured to protrude in a frontward direction from a door when opening or closing the door, thereby preventing accumulation of foreign substances such as dusts on the handle to keep the handle in a clean state, and improving user convenience. The handle is configured to retract to an inside of the door when the door is not being used.

### CROSS-REFERENCE TO RELATED APPLICATION

This application claims priority to and benefit of Korean Patent Application No. 10-2024-0022962, filed on Feb. 16, 2024, and Korean Patent Application No. 10-2024-0022973, filed on Feb. 16, 2024, which are hereby incorporated by reference as when fully set forth herein.

### TECHNICAL FILED

The present disclosure relates to a dish washer. More specifically, the present disclosure relates to a dish washer including a handle configured to reciprocate relative to a door.

### BACKGROUND

A dish washer is an apparatus that washes washing targets such as dishes and cooking utensils stored therein by spraying washing water thereto. The washing water may include detergent.

For instance, a dish washer may include a washing tub having a washing space defined therein, a dish rack that accommodates therein a washing target inside the washing tub, a spraying arm that sprays the washing water into the dish rack, and a sump that stores therein water and supplies the washing water to the spraying arm.

Using the dish washer may reduce a time and effort for washing the dishes and other washing targets after a meal, thereby contributing to user convenience.

In some cases, the dish washer may perform a washing cycle for washing a washing target, a rinsing cycle for rinsing a washing target, and a drying cycle for drying a washing target that has been washed and rinsed.

In order to store dishes inside the dish washer before the cycle proceeds, and to withdraw the washed and dried dishes after the cycle has been completed, the user may open and close the door. In some cases, the door may include a handle that the user may grasp for facilitating the opening and closing of the door.

For instance, a dish washer may include a depressed type handle that is provided at the door for the user to grasp when opening and closing the door. The handle may have a grip groove depressed from a front surface of the door toward a rear surface thereof by a predetermined depth. The handle may have a depressed form from a portion of the front surface of the door toward an inside of the door. Since a separate cover, etc., is not disposed on the handle, the handle is always exposed to an outside. Therefore, the handle has a structure in which external foreign substances such as dusts may accumulate in the depressed space into which the hand of the user is inserted. The user may frequently clean the handle, thereby causing inconvenience to the user. Furthermore, the handle may deteriorate the aesthetics of the front surface appearance of the door because the portion of the front surface of the door is concavely depressed.

In some cases, a dish washer may have a protruding type handle. For instance, the handle may have a predetermined protruding height in a frontward direction from a front surface of the door and may maintain the protruding state in a 90 degrees-rotated U shape. In some cases, a user may not recognize the protruding portion from the front surface of the door and collide with the protruding portion, thereby causing injury to the user. In some cases, the handle may collide with dishes and other kitchenware when the dishes are withdrawn from the dish washer, and thus there is a possibility of causing damage to the handle itself or items such as dishes.

In some cases, a dish washer may have a door (of a handless type) without a handle, where the user opens the door to a fully open state (by a large angle) by holding a portion (for example, a top portion) of the door. In this case, there is a risk that the user may get burned due to hot steam generated during or after the process of the dish washer.

### SUMMARY

The present disclosure describes a dish washer including a handle that is configured to extend in a protruding manner in a frontward direction from the door for use, such as when opening or closing the door, so that external foreign substances such as dusts are prevented from accumulating on the handle, thereby maintaining a clean state of the handle and improving user convenience.

The present disclosure further describes a dish washer including a handle that is configured to at least partially retract into an inside of the door when the handle is not being used, and a front end surface of the handle and a front surface of the door are configured to be coplanar with each other in the retracted state such that the user feels a sense of unity of the handle and the door with each other, thereby improving the aesthetics of the appearance of the dish washer.

The present disclosure further describes a dish washer including a handle that is configured to at least partially retract into the inside of the door when the handle is not being used, thereby reducing the possibility of user injury and handle damage that may occur due to collision of the user with the handle.

The present disclosure further describes a dish washer configured to detect the user's finger or an object between the handle and the door during a process of extending and retracting the handle, thereby reducing a possibility of injury to the user and damage to the handle, and thus, improving stability and reliability of the dish washer.

According to one aspect of the subject matter described in this application, a dish washer including a tub that defines a washing space configured to accommodate one or more objects to be washed therein, the tub having an open front surface that is in fluid communication with the washing space, a door configured to open and close the open front surface of the tub, a handle configured to reciprocate between (i) an extended position in a forward direction relative to the door and (ii) a retracted position in which the handle is at least partially accommodated within the door, and a handle driver disposed within the door and configured to move the handle from the retracted position toward the extended position or from the extended position toward the retracted position. The handle driver includes a pivot link having (i) a first end configured to rotate relative to the door and (ii) a second end that is connected to the handle and configured to rotate relative to the handle, a driving cam configured to (i) press the pivot link in a frontward direction based on the driving cam rotating in a first direction and (ii) press the pivot link in a rearward direction based on the driving cam rotating in a second direction opposite to the first direction, and a driving motor configured to generate a driving force for rotating the driving cam in the first direction or the second direction, the driving motor comprising a rotation shaft disposed below a vertical level of the handle.

Implementations according to this aspect can include one or more of the following features. For example, the door can be configured to pivot about a pivot axis relative to the tub to thereby open and close the open front surface of the tub, where a rotation direction of the door around the pivot axis to open the tub matches one of the first direction or the second direction of the drive motor to move the handle toward the extended position.

In some implementations, the driving cam can include a cam body configured to rotate based on the driving force of the driving motor, and a driving pin that protrudes from one side surface of the cam body toward the pivot link, where the pivot link defines a guide groove between the first end and the second end and, the guide groove receiving the driving pin. The driving pin can be configured to, based on the cam body rotating in the first or second direction, move relative to and along the guide groove to thereby cause the pivot link to pivot in the frontward or rearward direction.

In some examples, the driving pin can be located at a position that defines, in a state in which the handle is located at the extended position, a predetermined intersection angle between (i) a virtual first extension line extending from a rotation center of the cam body to a center of the driving pin and (ii) a virtual second extension line that is parallel to a movement direction of the handle to the extended position and extends through the rotation center of the cam body. For instance, the predetermined intersection angle can be less than or equal to 5 degrees.

In some implementations, the dish washer can further include a handle housing disposed inside the door and configured to receive the handle therein based on the handle moving to the retracted position, where the handle housing defines a rail groove configured to guide a reciprocating movement of the handle between the extended position and the retracted position. In some examples, the handle can include a guide protrusion that protrudes toward the rail groove and is inserted into the rail groove, where the guide protrusion is configured to move along the rail groove during the reciprocating movement of the handle.

In some implementations, the door can define an opening at a front surface thereof, where the handle is configured to reciprocate through the opening of the door during a reciprocating movement of the handle and configured to close the opening of the door based on the handle being disposed at the retracted position. In some examples, the opening is spaced apart from a top surface of the door by a vertical distance, and the opening is spaced apart from each of right and left side surfaces of the door by a left-right distance that is less than the vertical distance. In some implementations, the handle can have a front end surface that is configured to be coplanar with the front surface of the door based on the handle being disposed at the retracted position.

In some implementations, the handle can include a first handle body configured to be exposed out of the door based on the handle moving to the extended position, and a second handle body connected to a rear end of the first handle body and received inside the door. In some examples, a vertical width of the second handle body is greater than a vertical width of the first handle body. In some examples, a front surface of the second handle body can be configured to, based on the handle being disposed at the extended position, be disposed at a front surface of the door or rearward relative to the front surface of the door.

In some implementations, the dish washer can further include a controller configured to determine whether to move the handle driver and to control power to be supplied to the handle driver, where the controller is configured to control an operation of the handle driver to prevent an object or a hand of a user from being caught between the handle and the door while the handle moves from the extended position to the retracted position.

In some implementations, the dish washer can further include a first safety sensor configured to detect whether the hand of the user is present between the handle and the door, where the controller configured to, based on an output signal received from the first safety sensor, determine whether the hand of the user is present between the handle and the door for a first set time duration or longer, and based on a determination that the hand of the user is present between the handle and the door for a time duration greater than the first set time duration, initiate the operation of the handle driver to move the handle backwards toward the retracted position and decrease a movement speed of the handle after the operation of the handle driver has been initiated. In some examples, the first safety sensor can include a capacitive touch sensor or an infrared sensor.

In some implementations, the dish washer can further include a vibration element disposed at the handle and configured to generate a haptic vibration, where the controller is configured to turn on the vibration element to generate the haptic vibration based on the determination that the hand of the user is present between the handle and the door for the time duration greater than the first set time duration.

In some examples, the controller is configured to, after decreasing the movement speed of the handle, re-determine whether the hand of the user is still present between the handle and the door based on the output signal received from the first safety sensor. In some examples, the controller is further configured to, based on a determination that the hand of the user is still present between the handle and the door, stop the operation of the handle driver to stop a movement of the handle toward the retracted position.

In some implementations, the dish washer can further include a second safety sensor configured to detect whether the object or the hand of the user is present between the handle and the door, where the controller is further configured to, based on the output signal received from the first safety sensor, determine that the hand of the user is absent between the handle and the door for a time duration greater than the first set time duration, based on a determination that the hand of the user is absent between the handle and the door for the time duration greater than the first set time duration, initiate the operation of the handle driver to move the handle backwards, after the operation of the handle driver has been initiated, determine whether the object or the hand of the user is present between the handle and the door based on an output signal received from the second safety sensor, based on determination that the object or the hand of the user is present between the handle and the door, stop the operation of the handle driver to stop a movement of the handle toward the retracted position, and after the handle has stopped, start an operation of the handle driver to move the handle forwards toward the extended position.

In some implementations, the second safety sensor can include a strain sensor disposed on the handle or the handle driver, or a current sensor configured to detect electric current supplied to the handle driver.

In some implementations, the controller is further configured to determine whether a second set time duration has elapsed after starting the operation of the handle driver to move the handle forwards toward the extended position, based on a determination that the second set time duration has elapsed, re-determine whether the object or the hand of the user is present between the handle and the door based on the output signal received from the second safety sensor, and based on a determination that the object or the hand of the user is absent between the handle and the door, operate the handle driver to move the handle backwards toward the retracted position.

In some implementations, external foreign substances such as dusts may be prevented from accumulating on the handle, thereby maintaining a clean state of the handle and improving user convenience.

In some implementations, in the retracted state of the handle, the user feels a sense of unity of the handle and the door with each other, thereby improving the aesthetics of the appearance of the dish washer.

In some implementations, the dish washer can reduce the possibility of user injury and handle damage that may occur due to collision of the user with the handle.

In some implementations, the dish washer may effectively detect the user's finger or an object being caught into between the handle and the door during a process of extending and retracting the handle, thereby reducing a possibility of injury to the user and damage to the handle.

### BRIEF DESCRIPTION OF DRAWINGS

FIG. 1 is a front perspective view showing an example of a dish washer.

FIG. 2 is a schematic cross-sectional view of the dish washer as shown in FIG. 1.

FIG. 3 is a front perspective view showing an example of a handle of the dish washer that is moved to a retracted position.

FIG. 4 is a front perspective view showing the handle in FIG. 3 that is moved to an extended position.

FIG. 5 is an enlarged side view of FIG. 3.

FIG. 6 is a rear perspective view of the door as shown in FIG. 3 and shows a state in which a rear panel of the door is removed.

FIG. 7 is a rear perspective view showing an example of a handle driver as shown in FIG. 5.

FIG. 8 is an exploded perspective view of the handle driver as shown in FIG. 7.

FIG. 9 is an exploded perspective view showing an example of a pivot link, a link connector, and a connection pin among components of the handle driver as shown in FIG. 8.

FIG. 10 is a side view illustrating an example operation of the handle driver to initiate movement from the retracted position to the extended position for the handle.

FIG. 11 is a side view illustrating a state in which movement to the extended position of the handle has been completed.

FIG. 12 is a side view illustrating an example operation of the handle driver to initiate movement from the extended position to the retracted position of the handle.

FIG. 13 is an enlarged view of a portion of FIG. 11, and illustrates an example structure that can restrict the handle from being moved backwards under an external force applied to the handle.

FIG. 14 is a partial enlarged view showing a state in which the handle and the handle driver have been removed from the door.

FIG. 15 is a rear perspective view illustrating an example of a handle frame on which the handle and the handle driver are installed, where the handle frame supports the handle and the handle driver.

FIG. 16 is an exploded perspective view illustrating an example configuration of the handle.

FIG. 17 is a side view showing a state in which light is irradiated to an outside from the handle during a process in which the handle is moving to the extended position.

FIG. 18 is a functional block diagram illustrating an example configuration of a controller and functional modules included in a dish washer.

FIG. 19 is a flow chart showing an example of a sequence of cycles performed in a dish washer.

FIGS. 20 to 22 are flow charts respectively showing example steps of a method for controlling a dish washer.

### DETAILED DESCRIPTIONS

Hereinafter, the present disclosure will be described with reference to drawings showing a configuration.

Hereinafter, an overall structure of a dish washer 1 will be described in detail with reference to the attached drawings.

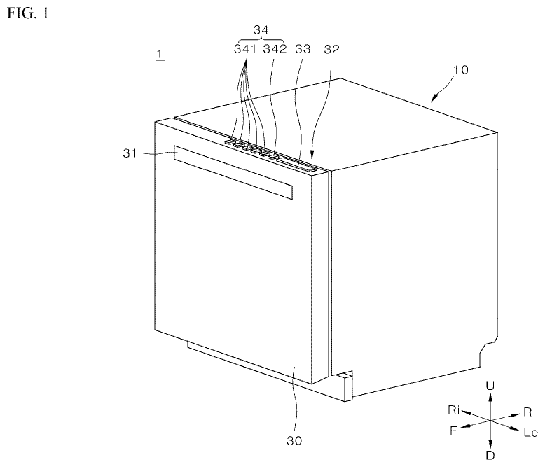

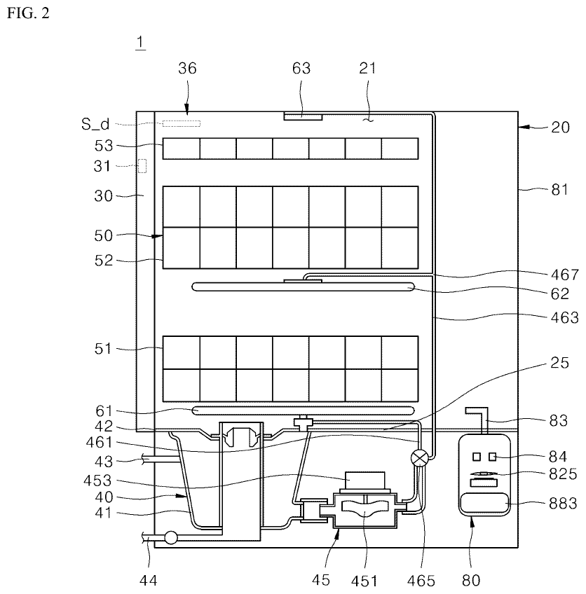

FIG. 1 is a front perspective view showing the dish washer 1 according to the present disclosure. FIG. 2 is a simplified cross-sectional view briefly showing an internal structure of the dish washer 1 according to the present disclosure.

As shown in FIG. 1 and FIG. 2, the dish washer 1 according to the present disclosure may include a casing 10 that constitutes an exterior appearance, a tub 20 installed in an inner space of the casing 10 and having a washing space 21 defined therein where the washing target is washed, wherein a front surface of the tub is open, a door 30 that opens/closes the open front surface of the tub 20, a driver 40 located under the tub 20 to supply, collect, circulate, and discharge the washing water for washing the washing target, a dish rack 50 removably provided in the inner washing space 21 of the tub 20 to receive therein the washing target, and a water sprayer installed adjacent to the dish rack 50 to spray the washing water for washing the washing target thereto.

In some examples, the washing target received in the dish rack 50 may be, for example, dishes such as bowls, plates, spoons, and chopsticks, and other cooking utensils. Hereinafter, unless otherwise specified, the washing target will be referred to as a dish.

The tub 20 may be formed in a box shape with an entirely open front surface, and have a configuration of a so-referred to as washing tub.

The washing space 21 may be defined inside the tub 20. The open front surface of the tub 20 may be opened/closing by the door 30.

The tub 20 may be formed via pressing of a metal plate resistant to high temperature and moisture, for example, a stainless steel plate.

Moreover, on an inner surface of the tub 20, a plurality of brackets may be disposed for the purpose of supporting and installing functional components such as the dish rack 50 and the water sprayer which will be described later thereon within the tub 20.

In one example, the driver 40 may include a sump 41 that stores therein washing water, a sump cover 42 that distinguishes the sump 41 from the tub 20, a water supply 43 that supplies washing water from an external source to the sump 41, a water discharger 44 that discharges the washing water of the sump 41 to an outside, and a washing pump 45 and a supply flow path 46 that supply the washing water of the sump 41 to the water sprayer. The sump cover 42 may be disposed at a top of the sump 41 and may serve to distinguish the tub 20 and the sump 41 from each other.

Moreover, the sump cover 42 may have a plurality of collecting holes defined therein for collecting washing water sprayed into the washing space 21 through the water sprayer into the sump 41.

That is, the washing water sprayed from the water sprayer toward the dish may fall down to a bottom of the washing space 21, and may be collected again through the sump cover 42 and into the sump 41.

The washing pump 45 may be disposed at one side of the sump 41 and may serve to pressurize the washing water and supply the pressurized washing water to the water sprayer.

One end of the washing pump 45 may be connected to the sump 41 and the other end thereof may be connected to the supply flow path 46. The washing pump 45 may be equipped with an impeller 451 and a motor 453. When power is supplied to the motor 453, the impeller 451 may rotate, and thus the washing water in the sump 41 may be pressurized, and then may be supplied to the water sprayer through the supply flow path 46.

In some examples, a wash water heater may be provided in the washing pump 45 to heat the wash water supplied during a wash cycle or a heat rinse cycle.

In one example, the supply flow path 46 may serve to selectively supply the washing water supplied from the washing pump 45 to the water sprayer.

For example, the supply flow path 46 may include a first supply flow path 461 connected to a lower spraying arm 61, and a second supply flow path 463 connected to an upper spraying arm 62 and a top nozzle 63. The supply flow path 46 may be provided with a supply flow path switching valve 465 that selectively opens/closes the supply flow paths 461 and 463.

In some examples, the supply flow path switching valve 465 may be controlled so that the supply flow paths 461 and 463 are opened sequentially or simultaneously.

In one example, the water sprayer may be configured to spray the washing water to the dishes stored in the dish rack 50.

More specifically, the water sprayer may include the lower spraying arm 61 located under the tub 20 to spray the washing water to a lower rack 51, the upper spraying arm 62 located between the lower rack 51 and an upper rack 52 to spray the washing water to the lower rack 51 and the upper rack 52, and the top nozzle 63 located on top of the tub 20 to spray the washing water to a top rack 53 or the upper rack 52.

In particular, the lower spraying arm 61 and the upper spraying arm 62 may be rotatably disposed in the washing space 21 of the tub 20 and may spray the washing water toward the dish of the dish rack 50 while being rotating.

The lower spraying arm 61 may be rotatably supported on a top of the sump cover 42 so as to spray the washing water toward the lower rack 51 while being rotating and being disposed under the lower rack 51.

Moreover, the upper spraying arm 62 may be rotatably supported by a spraying arm holder 467 so as to spray the washing water on the dish while being rotating and being disposed between the lower rack 51 and the upper rack 52.

In some examples, in order to increase washing efficiency, additional structure for diverting the washing water sprayed from the lower spraying arm 61 into an upward direction (diverting in a U-direction) may be provided at a lower surface 25 of the tub 20.

A detailed configuration of the water sprayer has been already known in the art. Thus, a description of the specific configuration of the water sprayer will be omitted below.

The dish rack 50 for storing the dish therein may be disposed in the washing space 21.

The dish rack 50 may be configured to extend or retract from or into the inner space of the tub 20 through the open front surface of the tub 20.

For example, in FIG. 2, an embodiment is shown in which the dish rack 50 includes the lower rack 51 located at a lower portion of the tub 20 to accommodate therein relatively large dishes, the upper rack 5 located on top of the lower rack 51 to accommodate therein medium-sized dishes, and the top rack 53 located at a top level of the tub 20 and capable of storing therein small dishes, etc. However, However, embodiments of present disclosure are not limited thereto. However, hereinafter, an example in which the dish washer 1 includes the three dish racks 50 as shown is described.

Each of the lower rack 51, the upper rack 52, and the top rack 53 may be configured to extend or retract from or into the inner space of the tub 20 through the open front surface of the tub 20.

For this purpose, guide rails may be respectively disposed on both opposing inner side surfaces constituting an inner surface of the tub 20. By way of example, the guide rails may include an upper rail, a lower rail, and a top rail.

Wheels may be disposed on a bottom of each of the lower rack 51, the upper rack 52, and the top rack 53. The user may extend the lower rack 51, the upper rack 52, and the top rack 53 from the inner space of the tub 20 through the open front surface of the tub 20 and may place the dishes thereon, or easily withdraw the dishes that have been washed out thereof.

The guide rail may be embodied as a simple rail-type fixed guide rail to guide the extending or the retracting of the rack 50, or a telescopic guide rail capable of guiding the extending or the retracting of the rack 50 and at the same time, increasing an extension distance thereof as the rack 50 further extends from the inner space of the tub.

In one example, the door 30 is configured for opening/closing the open front surface of the tub 20 as described above.

A hinge around which the door 30 is closed or opened may be provided at a bottom of the open front surface. Thus, the door 30 may pivot around the hinge as a pivot axis.

In some examples, a handle 31 for opening the door 30 and a control panel 32 for controlling an operation of the dish washer 1 may be disposed on an outer side surface of the door 30.

As shown, the control panel 32 may include a display 33 that visually displays information regarding a current operating status of the dish washer 1, etc., and a button unit 34 including a selection button through which a user's course selection manipulation is input and a power button through which a user's manipulation for turning the dish washer on and off is input.

In one example, a rear panel 30b constituting an inner side surface of the door 30 may constitute one surface of the tub 20 when the door 30 has been closed, and may constitute a seat surface on which the lower rack 51 of the dish rack 50 is supported when the door 30 is fully opened.

For this purpose, when the door 30 is fully opened downwardly, the rear panel 30b of the door 30 may constitute a horizontal plane extending in the same direction as a direction in which the guide rail guiding the displacement of the lower rack 51 extends.

In one example, unlike a conventional handle, the handle 31 of the dish washer 1 according to the present disclosure may be configured to be at least partially accommodated in an inside of the door 30 when the handle is not in use, and to automatically extend in a protruding manner in a frontward direction from the door 30 when it is necessary to open and close the door 30.

In that the handle is configured to retract so as to be at least partially accommodated in the inside of the door 30 or extend in a protruding manner in a frontward direction from the door 30 out of the inside of the door 30, the handle 31 may be referred to as various names such as a pop-up handle, a retractable handle, an extendable handle, etc.

Hereinafter, the handle 31 configured to retract into or extend from the door 30 of the dish washer 1 will be referred to as the pop-up handle 31.

In some examples, a detergent supply device for automatically supplying detergent into the inside of the tub 20 may be further installed on the rear panel 30b constituting an inner side surface of the door 30.

Furthermore, a door position sensor 36 may be disposed on an outer top surface of the tub 20 and may be configured to detect whether the door 30 is in a closed or open state. For example, the door position sensor 36 may include a door position sensor S_d or a latch sensor that detects a position of a door latch.

In one example, a drying air supply 80 may be disposed under the tub 20 and may be configured to generate and supply high-temperature or low-temperature drying air to the washing space inside the tub 20.

As shown, the drying air supply 80 may be configured to include a filter member 883 for filtering outside air, a blower fan 825 for generating a drying air stream, a heater 84 for heating the drying air stream, and an air stream guide 83 disposed inside the tub 20 so as to guide the drying air stream.

A drying air supply hole may be defined in a lower surface of the tub 20 so that high-temperature drying air generated by the drying air supply 80 may be introduced into the inside of the tub 20 through the drying air supply hole.

Thus, the high-temperature drying air or low-temperature drying air may be supplied from the drying air supply 80 into the inside of the tub 20 during the drying cycle S5 such that the drying efficiency and sterilization effect on the dishes may be improved compared to a conventional dish washer.

In one example, the dish washer may be configured such that the air current supplied to the inside of the tub 20 and moistened while drying the dishes may be discharged to the outside, and the discharge of the air current may be accomplished via partial opening of the door 30 or via a separate air discharge device.

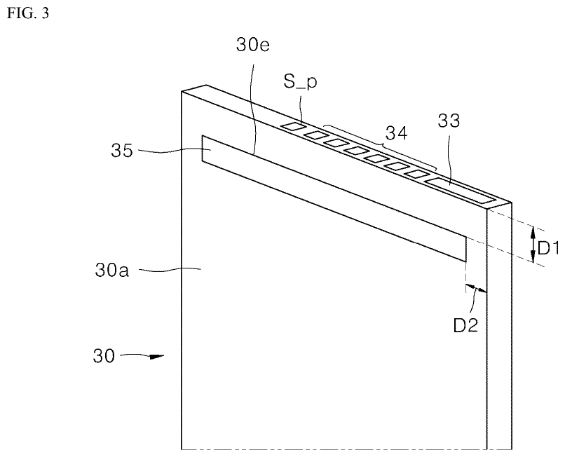

Hereinafter, with reference to FIGS. 3 to 5, the appearance and the operation of the pop-up handle 31 disposed at the door 30 of the dish washer 1 will be described in detail.

As described above, the door 30 of the dish washer 1 may be provided with the pop-up handle 31 that may be reciprocally movable.

In some examples, as described above, the door 30 may be configured to be pivotable around the hinge connected to a lower end of the door.

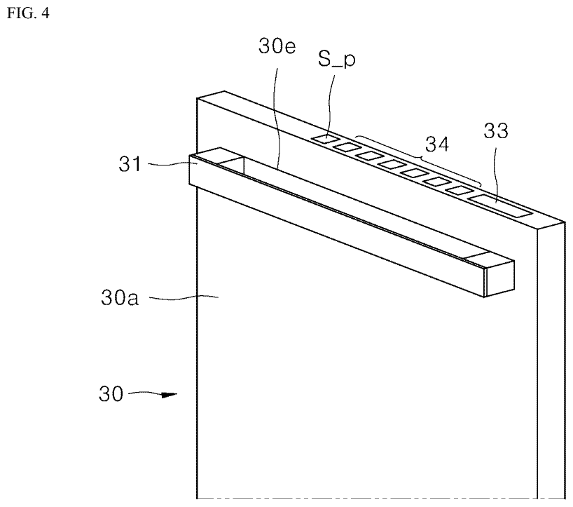

In consideration of the position of the hinge, as shown in FIG. 3 and FIG. 4, the pop-up handle 31 may be positioned at a position close to a top surface of the door 30 where the user may easily grasp the handle, and may be disposed at the front panel 30a constituting the front surface of the door 30.

Furthermore, the pop-up handle 31 may extend along an extension direction of a front edge of the top surface of the door 30 and along a left-right direction so that the user may easily grasp the handle. The handle 31 may be formed to have an approximate 90 degrees-rotated U shape.

In order to extend or retract the pop-up handle 31, an elongate opening 30e having a shape corresponding to an appearance of the pop-up handle 31 may be defined in the front panel 30a of the door 30 and extend along the extension direction of the front edge of the top surface of the door 30, and have a depth along a front-rear (F-R) direction

The pop-up handle 31 may be configured to reciprocate along the forward and backward directions through the opening 30e of the front panel 30a under an operation of a handle driver 35 as described below.

More specifically, in consideration of the opening and closing movement of the door 30 pivoting around a lower end thereof and the user's aesthetic sense, the opening 30e and the pop-up handle 31 can be disposed as close as possible to an upper end surface of the door 30.

That is, as illustrated in FIG. 3, the opening 30e may be defined in the front panel 30a in a state in which a predetermined vertical distance D1 is defined between the opening and the upper end surface of the door 30.

In addition, a predetermined left-right directional distance D2 may be defined between the opening 30e and each of the right and left side surfaces of the door 30.

For example, as shown in FIG. 3, the vertical distance D1 between the opening 30e and the upper end surface of the door 30 can be greater than the left-right directional distance D2 between the opening and each of the right side surface and the left side surface of the door 30.

As described above, since the vertical distance D1 is set to be greater than the left-right directional distance D2, a predetermined free space may be secured between the opening 30e and the upper end surface of the door 30, and thus the user's accessibility to the button 34 disposed on the upper end surface of the door 30 and the convenience of manipulation thereof may be improved.

Further, the pop-up handle 31 may be disposed to reciprocate between the most forward position and the most rearward position under the operation of the handle driver 35.

For convenience, the most forward position to which the pop-up handle 31 is displaced in a forward direction is defined as an extended position Pd. The most rearward position to which the pop-up handle 31 is displaced in a backward direction is defined as a retracted position Pa.

FIG. 3 illustrates a state where the pop-up handle 31 has been displaced to the most rearward position, that is, the retracted position Pa, and thus has been retracted into the inside of the door 30.

As shown, when the pop-up handle 31 has been displaced to the retracted position Pa, the pop-up handle 31 has been at least partially retracted into the inside of the door 30.

In some examples, the pop-up handle 31 may passing through an entirety of the opening 30e of the door 30 and be retracted into the inside of the door 30.

Furthermore, when the pop-up handle 31 has been displaced to the retracted position Pa, the pop-up handle 31 may be in a state where the pop-up handle 31 does not protrude from the front panel 30a of the door 30 in a frontward direction.

Furthermore, when the pop-up handle 31 has been displaced to the retracted position Pa, a front end surface of the pop-up handle 31 may be coplanar with a front surface of the front panel 30a of the door 30 so as to form a continuous surface.

That is, a state in which no step is formed between the front surface of the front panel 30a of the door 30 and the front end surface of the pop-up handle 31 may be formed when the pop-up handle 31 has been displaced to the retracted position Pa.

Thus, when the pop-up handle 31 has been displaced to the retracted position Pa, the opening 30e of the front panel 30a is entirely blocked, and at the same time, no step is formed between the front surface of the front panel 30a and the front end surface of the pop-up handle 31, such that the phenomenon in which foreign substances such as dusts accumulate on an convex portion of the door 30 or on the handle itself as in the conventional approach may be fundamentally prevented.

In one example, as described below, the front end surface of the pop-up handle 31 may be a front surface of a decoration panel 315 that is provided separately from a first handle body 311 that constitute the overall appearance of the pop-up handle 31.

In some examples, the decoration panel 315 may include a material having the same texture as that of the front panel 30a of the door 30.

Thus, the user may feel a sense of unity the decoration panel 315 and the front panel 30a of the door 30, and thus the aesthetic sensibility of the outer appearance of the door 30 may be improved and the aesthetics of the door which the user perceives may be improved.

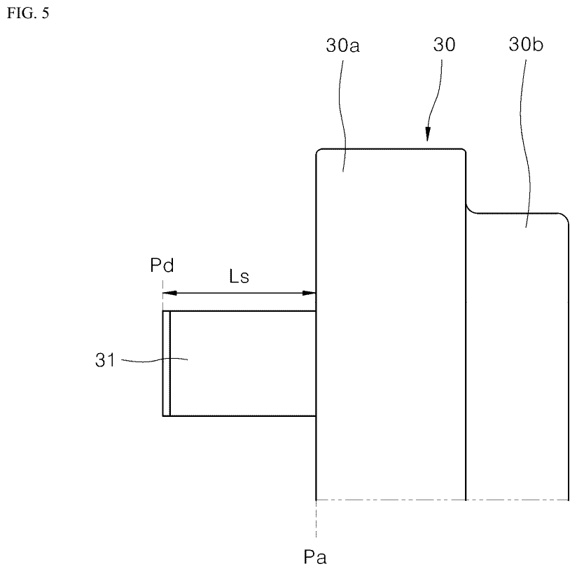

FIG. 4 and FIG. 5 illustrate a state in which the pop-up handle 31 has been displaced from the retracted position Pa to the extended position Pd as the most forward position.

As described above, the door 30 of the dish washer 1 should be opened and closed in order to store the dishes that need to be washed in the dish washer or to withdraw the dishes that have been washed out of the dish washer 1.

When the user's intention to open the door 30 is identified as being present at a time when opening/closing of the door 30 is performed, the pop-up handle 31 may be automatically moved from the retracted position Pa to the extended position Pd under the operation of the handle driver 35.

For this purpose, the dish washer 1 may further be provided with a detector or sensor for detecting the user's intention to open the door 30.

For example, a proximity sensor S_p may be embodied as the detector for detecting absence or presence of the user's intention to open the door 30.

The proximity sensor S_p may be a sensor that may detect whether the user approached so as to be located within a specific detection range from the door 30.

For example, the proximity sensor S_p may include any one of a radar sensor, an image sensor, or an infrared sensor (IR) Sensor.

However, embodiments of the present disclosure are not limited thereto. The proximity sensor S_p may be applied without limitation in terms of the type thereof as long as the proximity sensor S_p can identify proximity of the user to the door. The following description will be based on an example in which the radar sensor is applied as the proximity sensor S_p.

As shown in FIG. 3 and FIG. 4, the radar sensor as the proximity sensor S_p may be disposed on the control panel 32 and at a location close to the existing display 33 so as to easily identify the proximity of the user to an area in front of the door, and to facilitate modularization thereof with the existing display 33.

In this way, the radar sensor functioning as the proximity sensor S_p may be disposed on the control panel 32 constituting the top surface of the door 30 and may be configured to distinguish a user and a non-user such as a pet from each other.

In some implementations, the dish washer 1 may configured not to immediately move the pop-up handle 31 even when the radar sensor recognizes that the user is located within a predetermined detection range from the door 30.

This is because there may be cases where the user simply passes by the dish washer 1 without any intention to open the door 30.

Therefore, in some examples, the dish washer 1 may be further configured to add a time condition to identify absence or presence of the intention to open the door 30 through the proximity sensor S_p such as the radar sensor.

In some examples, when the dish washer 1 identifies that the user is present within a specific detection range from the door 30 through the radar sensor and continues to stay within the specific detection range for a specific time condition, the dish washer 1 may determine that the user has an intention to open the door 30.

In some examples, the specific detection range and the specific time condition may be set to vary depending on the environment in which the dish washer 1 is disposed and a physical condition of the user.

When the specific detection range condition and the specific time condition are satisfied, a controller 100 as described below is configured to initiate the operation of the handle driver 35 to move the pop-up handle 31 in the frontward direction from the retracted position Pa to the extended position Pd.

FIG. 4 and FIG. 5 illustrate the state in which the pop-up handle 31 has completed the forward movement to the extended position Pd.

When the pop-up handle 31 has completed its movement to the extended position Pd, the first handle body 311 of the pop-up handle 31 may be entirely exposed to the outside out of the door 30 and may be grasped by the user.

In some examples, a stroke Ls by which the pop-up handle 31 is displaced from the retracted position Pa to the extended position Pd may be in a range of 40 mm inclusive to 50 mm inclusive, e.g., 45 mm.

The stroke Ls of the pop-up handle 31 is determined in consideration of that when the stroke Ls is too small, such as smaller than 40 mm, it is not easy for the user to grasp the handle, while when the stroke Ls is too large, such as larger than 50 mm, a size of the pop-up handle 31 in the forward and backward direction increases, thereby causing a problem in that the pop-up handle 31 does not retract entirely into the door 30.

However, the numerical value of the movement stroke Ls of the pop-up handle 31 is only an example and may be set to vary depending on the overall size of the dish washer 1 and the size in the forward and backward direction of the door 30.

In one example, as the pop-up handle 31 moves to the extended position Pd, the first handle body 311 of the pop-up handle 31 comes out of the opening 30e of the front panel 30a of the door 30 and is exposed to the outside out of the door 30. Accordingly, the opening 30e is not blocked with the first handle body 311.

However, when the pop-up handle 31 moves to the extended position Pd as described below, a second handle body 312 connected to the first handle body 311 moves in the frontward direction together therewith, so that the opening 30e of the front panel 30a is blocked with the second handle body 312.

In some examples, the vertical width of the second handle body 312 may be greater than the vertical width of the first handle body 311, and may be greater than or equal to the vertical width of the opening 30e of the front panel 30a.

In addition, when the movement to the extended position Pd is completed, the front surface of the second handle body 312 and the front panel 30a constituting the front surface of the door 30 may be disposed at the same front-rear position, or the front surface of the second handle body 312 may be positioned in rear of the front panel 30a constituting the front surface of the door 30.

Therefore, even when the pop-up handle 31 has been moved to the extended position Pd, the opening 30e of the front panel 30a may be maintained in a blocked state, so that foreign substances such as dusts may be effectively prevented from entering the inside of the door 30.

Furthermore, since the observation of the inside of the door 30 through the opening 30e of the front panel 30a blocked with the second handle body 312, the deterioration of the aesthetic sense for the user may be effectively prevented.

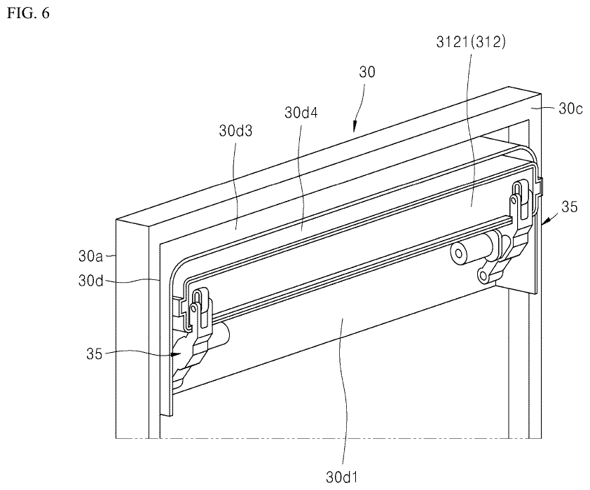

Hereinafter, referring to FIG. 6 to FIG. 13, the detailed configuration of the handle driver 35 that actuates the pop-up handle 31 so that the pop-up handle 31 moves back and forth between the extended position Pd and the retracted position Pa is described.

First, referring to FIG. 6, in consideration of a shape of each of the first handle body 311 and the second handle body 312 of the pop-up handle 31 that extends in an elongate manner in the left-right direction, a pair of handle drivers 35 may be disposed separately and respectively on a left end and a right end of the pop-up handle 31.

That is, the pair of handle drivers 35 may be separated from each other and spaced from each other along the left-right direction and may be respectively on a left end and a right end of the pop-up handle 31 so as to respectively transmit a driving force for moving the pop-up handle 31 to the left end and the right end of the pop-up handle 31 which are accommodated inside a handle housing 30d4.

In this way, the pair of handle drivers 35 are disposed in a state separated from each other and spaced form each other along the left-right direction, the driving force generated from each of the handle drivers 35 may be transmitted to each of the left and right ends of the pop-up handle 31.

Accordingly, since driving loads applied to the handle drivers 35 are distributed, the miniaturization of each of the handle drivers 35 may be achieved, and thus, the manufacturing cost may be reduced.

However, this is only an example. Alternatively, the pop-up handle 31 may be driven using only a single handle driver. Hereinafter, an embodiment in which the pair of handle drivers 35 are provided will be described. However, embodiments of present disclosure are not limited thereto.

As illustrated, the left handle driver 35 and the right handle driver 35 may have shapes symmetrical with each other and may be arranged symmetrically with each other around the pop-up handle 31, and may be fixedly installed on a handle frame 30d.

Therefore, the right and left handle drivers 35 may be configured to be identical with each other except for the fact that the left handle driver 35 and the right handle driver 35 have shapes symmetrical with each other and are arranged symmetrically with each other around the pop-up handle 31.

Therefore, the following description will be based on the handle driver 35 disposed at the left side. Unless otherwise described, the following content may be equally applied to the handle driver 35 disposed at the right side.

In general, the door 30 of the dish washer 1 may have a small thickness to secure a wider washing space and for the user to easily open the door 30.

Due to such a small thickness, the position of the driving motor 351 of the handle driver 35 that generates a driving force for automatically operating the pop-up handle 31 may be limited.

More specifically, when the handle driver 35 is disposed directly in rear of the pop-up handle 31, there is a problem in that the thickness of the door 30 should be considerably increased.

In addition, when the handle driver 35 is disposed on top of the pop-up handle 31, there is a possibility that the handle driver may be superposed with the controller 100 disposed at the upper end of the door 30.

In addition, the vertical position of the pop-up handle 31 may be lowered to prevent the handle driver 35 from being superposed with the controller 100. In this case, as the position of the pop-up handle 31 is lowered, thereby causing inconvenience in gripping the pop-up handle 31 and causing the pop-up handle 31 to be visible to the user's eyes, which may cause a problem in that aesthetic impression is not good.

In consideration of the above problems, a vertical level of the driving motor 351 constituting the handle driver 35 may be lower than a vertical level of each of the pop-up handle 31 and the opening 30e of the door 30.

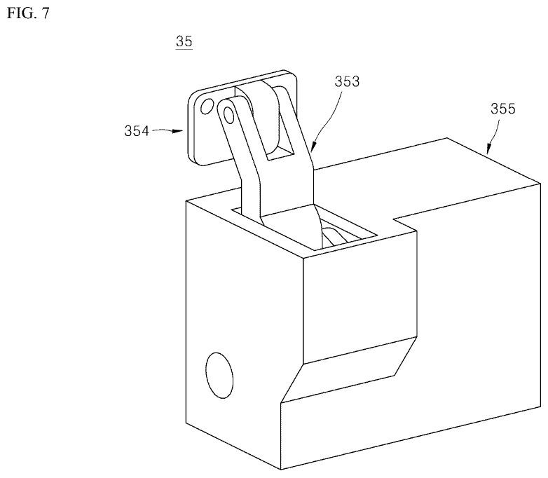

As shown in FIG. 7 to FIG. 9, the handle driver 35 that generates the driving force for the reciprocating movement of the pop-up handle 31 may be configured to include a driving motor 351 that receives power and generates a rotational driving force, a driving cam 352 that spins under the rotational driving force of the driving motor 351, a pivot link 353 that pivots around one end thereof in conjunction with the spin motion of the driving cam 352 so as to push or pull the pop-up handle 31, a link connector 354 that connects the pivot link 353 and the pop-up handle 31 to each other, and a housing 355 that accommodates therein the driving motor 351, the driving cam 352, and the pivot link 353.

The driving motor 351 is configured to receive power and generate a rotational driving force.

As described above, the pop-up handle 31 may be configured to repeatedly move forwards from the retracted position Pa toward the extended position Pd and move backwards from the extended position Pd toward the retracted position Pa and thus to reciprocate between the extended position Pd and the retracted position Pa.

In order to easily implement such reciprocating movement, the driving motor 351 constituting the handle driver 35 may be configured to generate a bidirectional rotation driving force.

Accordingly, the driving motor 351 applied to the handle driver 35 may be applied without limitation in terms of the type thereof as long as the driving motor 351 is capable of generating the bidirectional rotation driving force.

Hereinafter, among the bidirectional rotation driving (forces), the driving (driving force) in the direction in which an output shaft 3512 of the driving motor 351 rotates to move the pop-up handle 31 in the frontward direction toward the extended position Pd is referred to as forward direction rotation driving (forward direction rotation driving force), while the driving (driving force) in the direction in which the output shaft 3512 of the driving motor 351 rotates to move the pop-up handle 31 backwards toward the retracted position Pa is referred to as reverse direction rotation driving (or reverse direction rotation driving force). In this case, as illustrated, the output shaft 3512 of the driving motor 351 extends, for example, in the left-right direction and in parallel to the front surface of the door 30. Accordingly, a direction in which the door 30 pivots about the pivot axis when the tub 20 is opened and a direction in which the output shaft 3512 of the driving motor 351 rotates when the pop-up handle 31 moves toward the extended position may be the same as each other.

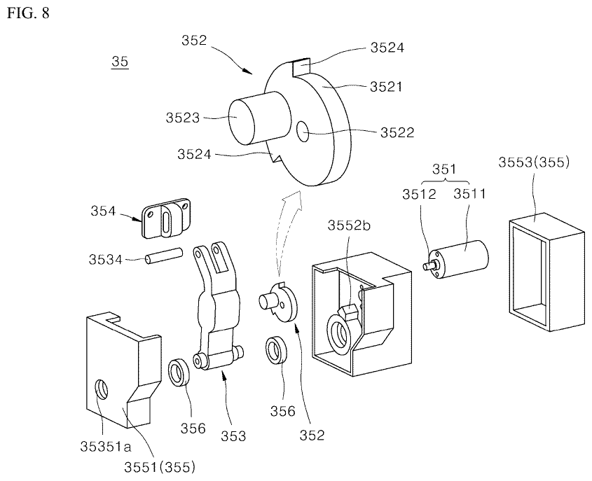

In one example, as shown in FIG. 8, a motor body 3511 of the driving motor 351 may be accommodated in an accommodation space formed between a second housing 3552 and a third housing 3553, and the output shaft 3512 of the driving motor 351 may extend thorough the second housing 3552 and be connected to the driving cam 352.

As described below, the output shaft 3512 of the driving motor 351 may be inserted into a shaft hole 3522 of the driving cam 352, and may be forcibly coupled to the shaft hole 3522.

Thus, the output shaft 3512 of the driving motor 351 may rotate integrally with the driving cam 352.

In one example, the driving cam 352 receives the rotation driving force from the output shaft 3512 of the driving motor 351 and transmits the received rotation driving force to the pivot link 353.

More specifically, when the driving cam 352 rotates in the forward direction in conjunction with the rotation of the output shaft 3512 of the driving motor 351, the driving cam 352 pressurizes the pivot link 353 so that the pivot link 353 pivots in the frontward direction. When the driving cam 352 rotates in the reverse direction in conjunction with the rotation of the output shaft 3512 of the driving motor 351, the driving cam 352 pressurizes the pivot link 353 so that the pivot link 353 pivots in the backward direction.

For this purpose, the driving cam 352 may be configured to include a cam body 3521 that spins under the rotation driving force transmitted from the output shaft 3512 of the driving motor 351, and a driving pin 3523 that is disposed on one side surface of the cam body 3521 and protrudes toward the pivot link 353.

The cam body 3521 may be provided in a form of a disk having an approximately uniform thickness, for example.

The shaft hole 3522 to which the output shaft 3512 of the driving motor 351 is forcibly inserted may extend through a center portion of the cam body 3521.

In order to easily implement integral rotation of the cam body 3521 and the motor shaft 3512 via the forcible coupling between the output shaft 3512 and the shaft hole 3522, the output shaft 3512 and the shaft hole 3522 may be connected to each other via a spline coupling, etc.

In one example, the driving pin 3523 plays a role of transmitting the rotation driving force of the cam body 3521 to the pivot link 353.

As illustrated, the driving pin 3523 may be formed to protrude from one side surface facing the pivot link of the cam body 3521 toward the pivot link 353, and may be positioned at a position spaced apart from the shaft hole 3522 by a predetermined distance in a radial direction.

Therefore, when the cam body 3521 spins around the shaft hole 3522, the driving pin 3523 rotates around the shaft hole 3522.

The driving pin 3523 is connected to the pivot link 353 while being inserted into a guide groove 3533 of the pivot link 353 as described later.

Accordingly, while the driving pin 3523 rotates around the shaft hole of the cam body 3521, the driving pin 3523 pressurizes the pivot link 353 so that the pivot link 353 pivots in a frontward or backward direction.

In one example, a rotation range of the driving pin 3523 or a spin range of the cam body 3521 needs to be smaller than an extension length of the guide groove 3533 provided in the pivot link 353. This is because when the rotation range is larger than the extension length of the guide groove 3533, there is a possibility that the driving pin 3523 or the guide groove 3533 may be damaged.

A stopper protrusion 3524 acting as a structure for limiting the rotation range of the driving pin 3523 or the spin range of the cam body 3521 may be disposed on an edge of the cam body 3521 and protrude along a radial direction thereof.

As illustrated, the stopper protrusion 3524 may be embodied as a predetermined step formed on the edge of the cam body 3521.

The stopper protrusion 3524 embodied as the step may be provided as a pair of stopper protrusions spaced apart from each other along a circumferential direction of the cam body which may limit the rotation range of the driving pin 3523 or the spin range of the cam body 3521 in both opposing directions.

In this way, the stopper protrusion 3524 may limit the rotation range of the driving pin 3523 or the spin range of the cam body 3521 to a circumferential range defined between the pair of stopper protrusions 3524.

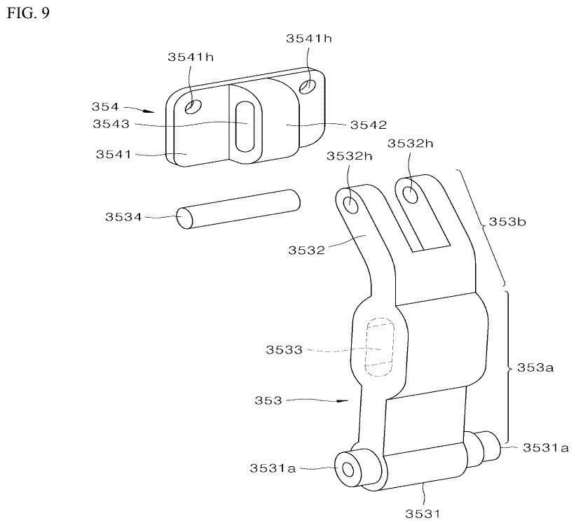

As shown in FIG. 9, a cam stopper 3552b corresponding to the pair of stopper protrusions 3524 may be provided inside the second housing 3552 that accommodates the driving cam 352.

In one example, the pivot link 353 receives the driving force from the driving pin 3523 of the driving cam 352 so as to push the pop-up handle 31 so that the pop-up handle 31 moves forwards or pull the pop-up handle 31 so that the pop-up handle 31 moves backwards.

As shown in FIG. 9, the pivot link 353 may be, for example, a bar-type link extending from a first end 3531 toward a second end 3532 thereof in a bar shape.

In some examples, the first end 3531 of the pivot link 353 as the bar-type link may be supported by the first housing 3551 and the second housing 3552 such that the pivot link only relatively rotates with respect to the first housing 3551 and the second housing 3552, that is, only pivots with respect to the first housing 3551 and the second housing 3552.

Accordingly, the pivot link 353 may pivot around the first end 3531 when the pressing force of the driving pin 3523 of the driving cam 352 is applied thereto.

For this purpose, a pair of shaft bosses 3531a that serve as a pivot center of an entirety of the pivot link 353 may be provided at both opposing sides of the first end 3531 of the pivot link 353, respectively.

The pair of shaft bosses 3531a may be formed to protrude toward the first housing 3551 and the second housing 3552 so as to have a predetermined protrusion height from one side surface and the other side surface of the first end 3531 of the pivot link 353, respectively.

A bushing 356 or a bearing may be fitted around each of the pair of shaft bosses 3531a to reduce friction. The pair of shaft bosses 3531a may be connected to the first housing 3551 and the second housing 3552, respectively, while each bushing 356 is fitted around each of the pair of shaft bosses 3531a.

Each of the first housing 3551 and the second housing 3552 may be formed to have each of cylindrical bushing receiving portions 3551a and 3552a into which each bushing 356 may be inserted.

The pivot link 353 may be formed to have the guide groove 3533 into which the driving pin 3523 of the driving cam 352 as described above is inserted.

As illustrated, the guide groove 3533 may be formed between the first end 3531 and the second end 3532, and may be defined in a first extension 353a of the pivot link 353 as described below.

The guide groove 3533 may linearly extend along a length direction of the first extension 353a. Movement of the driving pin 3523 may be guided along the extension direction of the guide groove 3533 so that the driving pin 3523 moves relative to and along the guide groove 3533 while being inserted into the guide groove 3533.

In one example, the second end 3532 of the pivot link 353 may be connected to the second handle body 312 of the pop-up handle 31 so as to be relatively pivotable with respect thereto, and may be configured to move the pop-up handle 31 forwards or backwards by pushing or pulling the second handle body 312 when the pivot link 353 pivots.

The second end 3532 of the pivot link 353 may be connected to the second handle body 312 via a connection pin 3534 so that the second end 3532 of the pivot link 353 may be pivotable relative to the second handle body 312.

In some examples, the link connector 354 may be further provided as a component for mutually connecting the second end 3532 of the pivot link 353 and the second handle body 312 to each other.

As illustrated, in one example, the link connector 354 may be configured to include a handle connection portion 3541 that is fastened to the second handle body 312 as described below, and a link connection portion 3542 that is indirectly connected to the second end 3532 via the connection pin 3534.

The handle connection portion 3541 may be formed in a flat shape so as to make surface contact with the second handle body 312 in order to secure a maximum contact area with the second handle body 312.

The handle connection portion 3541 may be formed to have a plurality of screw holes 3541h defined therein so that a connecting apparatus such as a screw bolt may pass through each screw hole.

The link connection portion 3542 may be indirectly connected to the second end 3532 of the pivot link 353 via the connection pin 3534.

For this purpose, a pin guide hole 3543 may be formed in the link connection portion 3542 and extend through the link connection portion along the left-right direction.

As illustrated, the pin guide hole 3543 may linearly extend along the vertical direction. The movement of the connection pin 3534 may be guided so that the connection pin moves relative to and along the pin guide hole 3543 in the vertical direction while being inserted into the pin guide hole 3543.

Therefore, when the pivot link 353 pivots, the connection pin 3534 coupled to the second end 3532 of the pivot link 353 moves along the pin guide hole 3543, thereby pushing the link connector 354 forwards or pulling the link connector backwards, thereby causing the pop-up handle 31 to move forwards or backwards.

In order to allow the connection pin 3534 to be connected in this way, left and right pin holes 3532h through which the connection pin 3534 passes may extend through the second end 3532 of the pivot link 353 along the left-right direction and may be arranged along the left-right direction.

Furthermore, the second end 3532 of the pivot link 353 may be formed in a branched form as illustrated in order to prevent interference with the link connection portion 3542 that moves relative to the second end 3532.

In one example, as described above, the pivot link 353 pivots around the first end 3531 to push or pull the link connector 354 and the second handle body 312 to generate the forward or backward movement stroke Ls of the pop-up handle 31.

In order to minimize a pivot amount of the pivot link 353 and maximize the frontward-backward movement stroke Ls of the pop-up handle 31, the second end 3532 of the pivot link 353 may extend in an inclined manner toward the second handle body 312 of the pop-up handle 31.

That is, as shown in FIG. 9, the pivot link 353 may include a first extension 353a that extends radially from the first end 3531, and a second extension 353b that extends in a bent manner toward the pop-up handle 31 and between the first extension 353a and the second end 3532.

In this way, the second extension 353b is formed to be bent or curved toward the pop-up handle 31, thereby greatly increasing a stroke Ls by which the second handle body 312 of the pop-up handle 31 is pushed or pulled.

### Movement of the Pop-Up Handle Under Operation of Handle Driver

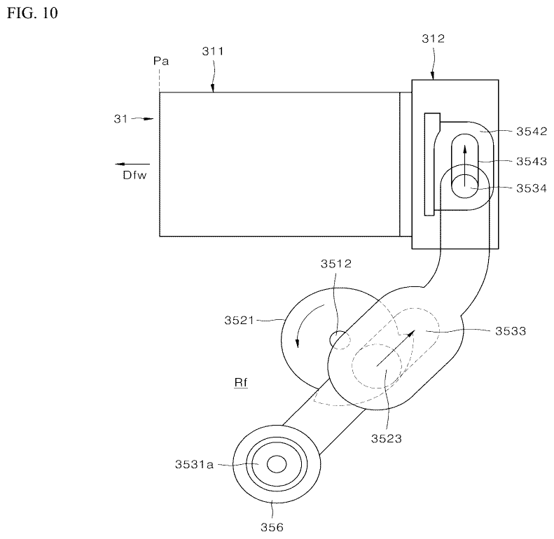

Referring to FIG. 10 to FIG. 13, a process in which the pop-up handle 31 moves forwards to the extended position Pd or moves backwards to the retracted position Pa under the operation of the handle driver 35 will be described below.

First, FIG. 10 illustrates a situation in which the pop-up handle 31 automatically moves forwards along the forward direction Dfw from the retracted position Pa toward the extended position Pd.

Referring to FIG. 10, when the pop-up handle 31 has been displaced to the retracted position Pa, the power is supplied to the driving motor 351, such that the operation of the driving motor 351 is initiated, and the driving motor 351 generates the forward direction rotation driving force.

Accordingly, the forward direction rotation of the output shaft 3512 of the driving motor 351 may be initiated, and the forward direction spin of the driving cam 352 forcibly connected to the output shaft 3512 may be initiated.

At this time, when the forward direction rotation is initiated, the output shaft 3512 and the driving cam 352 may start to rotate counterclockwise based on the illustrated state.

In one example, as the forward direction spin of the driving cam 352 is initiated, a forward direction rotation of the driving pin 3523 may be initiated.

As shown in FIG. 10, the driving pin 3523 which has been located at a lower end of the guide groove 3533 of the pivot link 353 may start to move to a top of the guide groove 3533.

As the driving pin 3523 rotates in the forward direction, the driving pin moves to the top from the bottom of the guide groove 3533, such that the driving pin 3523 presses the pivot link 353 such that the pivot link pivots forwards around the first end 3531 That is, based on the illustrated state, the pivot link 353 pivots counterclockwise around the first end 3531.

At this time, as the pivot link 353 pivots around the first end 3531, the second end 3532 of the pivot link 353 also pivots forwards, and the connection pin 3534 connected to the second end 3532 pivots forwards.

Accordingly, the driving pin 3523 which has been located at the bottom of the guide hole 3543 of the link connector 354 moves to the top of the guide hole 3543.

As the connection pin 3534 moves to the top from the bottom of the guide hole 3543, the connection pin 3534 presses the link connector 354 and the second handle body 312 to push forwards. That is, while the connection pin 3534 moves relative to the guide hole 3543 and along the guide hole 3543, a pressure force is applied to the link connector 354 to push the link connector 354 forwards.

In this way, the operation of the handle driver 35 is initiated, such that the driving cam 352 has completely rotated along a preset rotation range. Then, the power supply to the driving motor 351 may be cut off, and the forward movement of the pop-up handle 31 to the extended position Pd may be completed.

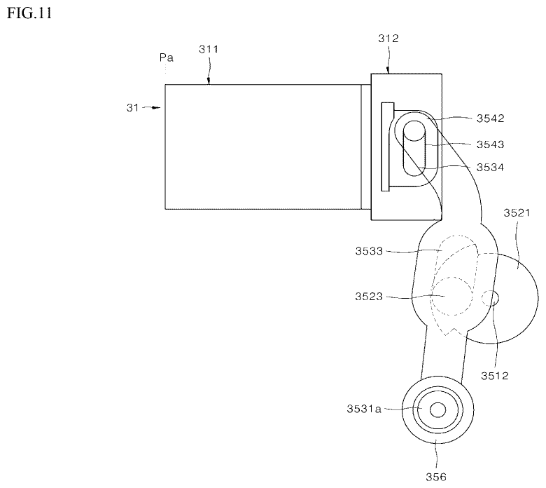

FIG. 11 shows the state in which the pop-up handle 31 has completed the forward movement to the extended position Pd and has stopped.

When the forward movement of the pop-up handle 31 to the extended position Pd has been completed in this way, an entirety of the first handle body 311 may be exposed to the outside out of the door 30, and thus, the user may easily perform the action of opening or closing the door 30 while holding the first handle body 311.

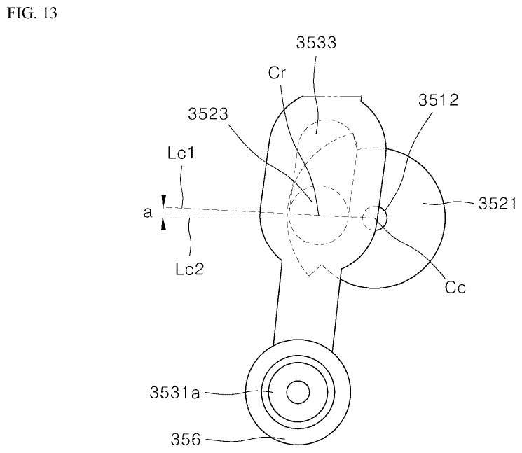

In some examples, as shown in FIG. 13, when the pop-up handle 31 has been displaced to the extended position Pd, the first extension 353a of the pivot link 353 has stood upright, and the driving pin 3523 of the driving cam 352 has been moved to the bottom of the guide groove 3533.

Therefore, as shown, a predetermined intersection angle a may be defined between a virtual first extension line Lc1 connecting a center Cr of the driving pin 3523 and a rotation center Cc of the shaft hole 3522 as a rotation center of the cam body 3521 and a virtual second extension line Lc2 which is parallel to a moving direction Drw/Dfw of the pop-up handle 31 and passes through the rotation center Cc of the shaft hole 3522 of the cam body 3521. In some examples, the intersection angle “a” may be a small angle. For example, the intersection angle “a” may be in a range of 0 degrees inclusive to 5 degrees inclusive.

The small intersection angle “a” in a range of 5 degrees or smaller is defined in this way. Thus, a structure may be achieved in which the first handle body 311 is fixed at the extended position Pd without being removed from the extended position Pd even when a user's pressure to open or close the door 30 is applied to the first handle body 311 of the pop-up handle 31.

That is, a structure in which the pop-up handle 31 may be effectively fixed at the extended position Pd may be achieved by a position arrangement of the pivot link 353 and the driving cam 352 while a separate removal-prevention structure or fixing device is not disposed at the pop-up handle 31 and the handle frame 30d as described below.

Thus, in the dish washer 1, a structure of a combination of the pop-up handle 31, the handle driver 35, and the handle frame 30d may be simplified, and a manufacturing cost thereof may be reduced.

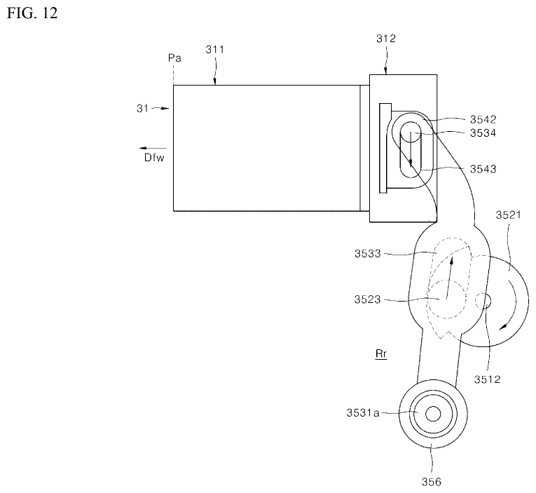

FIG. 12 illustrates a situation in which the pop-up handle 31 automatically moves backwards along the backward direction Drw from the extended position Pd toward the retracted position Pa.

Referring to FIG. 12, the pop-up handle 31 has moved to the extended position Pd and has stopped. Then, after a predetermined waiting time has elapsed, the power is supplied to the driving motor 351, the driving motor 351 starts operating, and the driving motor 351 generates the reverse rotation driving force. As will be described below, the predetermined waiting time may be in a range of 2.5 seconds to 3.5 seconds.

Accordingly, the reverse rotation of the output shaft 3512 of the driving motor 351 starts, and the reverse spin of the driving cam 352 forcibly connected to the output shaft 3512 may start.

When the reverse rotation starts, the output shaft 3512 and the driving cam 352 may start to rotate clockwise based on the illustrated state.

Further, as the reverse spin of the driving cam 352 starts, the reverse revolution of the driving pin 3523 may start.

As shown in FIG. 11, the driving pin 3523 which has been positioned at the bottom of the guide groove 3533 of the pivot link 353 may start to move relative to the guide groove 3533 and to the top of the guide groove 3533.

As the driving pin 3523 rotates in the reverse direction, the driving pin moves relative to the guide groove 3533 and to the top from the bottom of the guide groove 3533, the driving pin 3523 presses the pivot link 353 to pivot in the rearward direction around the first end 3531. That is, based on the shown state, the pivot link 353 pivots clockwise around the first end 3531.

In some examples, as the pivot link 353 pivots around the first end 3531, the second end 3532 of the pivot link 353 also pivots in the rearward direction, and the connection pin 3534 connected to the second end 3532 pivots in the rearward direction.

Accordingly, the driving pin 3523 which has been located at the top of the guide hole 3543 of the link connector 354 moves relative to the guide hole 3543 and to the bottom of the guide hole 3543.

As the connection pin 3534 moves relative to the guide hole 3543 and from the top to the bottom of the guide hole 3543, the connection pin 3534 applies the pressure the link connector 354 to pull the link connector 354 in the rearward direction. That is, while the connection pin 3534 moves relative to and along the guide hole 3543, a pressure force is applied to the link connector 354 to pull the link connector 354 in the rearward direction.

In this way, the operation of the handle driver 35 has been initiated, and then, the driving cam 352 has completed the reverse pivot motion thereof along the preset rotation range. Then, the power supply to the driving motor 351 may be cut off, and the backward movement of the pop-up handle 31 to the retracted position Pa may have been completed.

### Guide of Linear Movement of the Pop-Up Handle

As described above, the pop-up handle 31 is configured to move forwards or backwards under the forward direction driving force or the reverse direction driving force of the handle driver 35.

However, as described above, the pop-up handle 31 may be configured to move horizontally or linearly along the forward direction Dfw or the backward direction Drw.

A structure for implementing the horizontal or linear movement may be provided in the pop-up handle 31 and the handle frame 30d in which the pop-up handle 31 is accommodated.

As described above, the pop-up handle 31 may be configured to include the first handle body 311 that is exposed to the outside out of the door 30 and may be gripped by the user when the handle has been moved to the extended position Pd, and the second handle body 312 that is connected to a rear end of the first handle body 311 and is disposed inside the door 30 when the handle has been moved to the extended position Pd and the retracted position Pa.

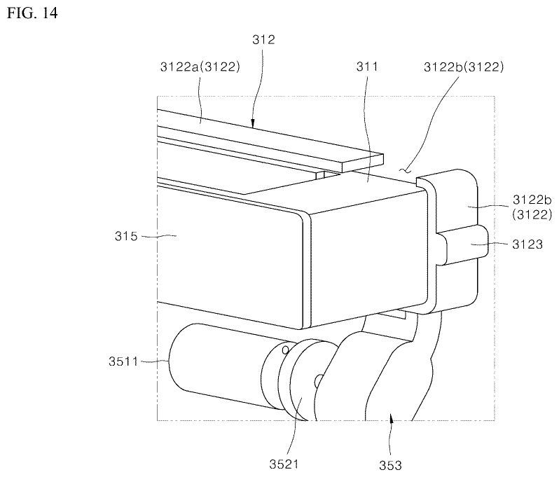

As illustrated in FIG. 14, the second handle body 312 may include a plate-shaped panel 3121 that serves to screen the opening 30e formed in the front panel 30a of the door 30 when the pop-up handle 31 has been moved to the extended position Pd, and an edge rib 3122 that extends along an edge of the panel 3121 and extends rearwardly so as to be away from the first handle body 311.

As described above, the link connector 354 of the handle driver 35 may be attached to a rear surface of the panel 3121 constituting the second handle body 312.

That is, the driving force of the handle driver 35 may be transmitted to the panel 3121 of the second handle body 312 via the link connector 354, and may be transmitted to the first handle body 311 via the panel 3121.

The edge rib 3122 extends along the edge of the panel 3121 and serves to reinforce rigidity of the panel 3121 and prevent the pop-up handle 31 from being removed from the door 30 when the handle is pulled by the user.

In order to perform the removal prevention function, the edge rib 3122 may be formed to have a width in the vertical direction and a width in the left-right direction larger than those of each of the opening 30e of the front panel 30a of the door 30 and an opening 30d2 of a handle frame 30d described later.

Due to the size of the edge rib 3122, when the first handle body 311 is pulled, a front surface of the edge rib 3122 may collide with an inner surface of the handle frame 30d, thereby preventing the first handle body 311 and the second handle body 312 from being removed from the door.

In one example, a vertical extension 3122b of the edge rib 3122 may have a guide protrusion 3123 that protrudes so as to be away from the edge rib 3122.

As shown in FIG. 14, the guide protrusion 3123 may have a shape having a constant thickness in the vertical direction and extending in an elongate manner along a direction parallel to the forward direction Dfw or the backward direction Drw of the pop-up handle 31.

The guide protrusion 3123 may be inserted into a rail groove 30d45 of the handle housing 30d4 described below. As the guide protrusion 3123 moves along the rail groove 30d45, the first handle body 311 and the second handle body 312 move horizontally or linearly.

Therefore, a combination of the guide protrusion 3123 of the second handle body 312 and the rail groove 30d45 of the handle housing 30d4 may be an example structure for implementing the horizontal or linear movement of the pop-up handle 31.

FIG. 14 shows a configuration in which only a left portion of the edge rib 3122 is provided with the guide protrusion 3123. However, embodiments of the present disclosure are not limited thereto. A right portion of the edge rib 3122 opposite to the left portion thereof may also be provided with the guide protrusion 3123.

Furthermore, as shown in FIG. 14, the horizontal extension 3122a of the second handle body 312 may have a notch 3122c defined therein whose left-right width is maintained to be constant.

A protruding surface portion 30d46 of the handle housing 30d4 described later may be inserted into the notch 3122c.

A left-right width of the protruding surface portion 30d46 may be maintained to be constant in a corresponding manner to a shape of the notch 3122c.

When the first handle body 311 and the second handle body 312 have been accommodated in the handle housing 30d4, the protruding surface portion 30d46 may be inserted into the notch 3122c. Therefore, when the pop-up handle 31 moves, the notch 3122c moves along the protruding surface portion 30d46, such that the first handle body 311 and the second handle body 312 move horizontally or linearly.

Therefore, a combination of the notch 3122c of the second handle body 312 and the protruding surface portion 30d46 of the handle housing 30d4 may be an example structure for implementing the horizontal or linear movement of the pop-up handle 31.

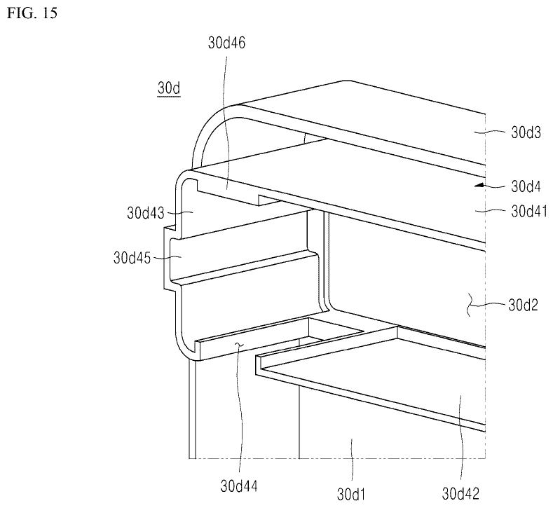

FIG. 15 illustrates the handle frame 30d including the handle housing 30d4 in which the first handle body 311 and the second handle body 312 are accommodated.

The handle frame 30d supports the aforementioned handle driver 35 attached thereto and receives therein and supports the pop-up handle 31 so as to be movable therein.

The handle frame 30d may include a panel portion 30d1 and an outer wall 30d3 that serve as a support surface or an attachment surface to support the handle driver 35.

The panel portion 30d1 and the outer wall 30d3 of the handle frame 30d may be fixed to an inner surface of the front panel 30a or the rear panel 30b of the door 30.

In one example, the handle frame 30d may further include the handle housing 30d4 to accommodate therein and support the pop-up handle 31 so as to be movable therein.

As illustrated, the handle housing 30d4 may be provided in a box shape with open front and rear surfaces so that the first handle body 311 and the second handle body 312 may be entirely accommodated in the handle housing in a state where the pop-up handle 31 has been moved to the retracted position Pa.

The open front surface of the handle housing 30d4 may act as the opening 30d2 through which the first handle body 311 extends or retracts.

The opening 30d2 of the handle housing 30d4 may be formed at a position corresponding to a position of the opening 30e of the front panel 30a of the door 30 and may have a corresponding size to a size of the opening 30e.

The handle housing 30d4 may be provided with the rail groove 30d45 and the protruding surface portion 30d46, each configured to implement the horizontal or linear movement of the pop-up handle 31 as described above.

The rail groove 30d45 may be formed in each of a left side surface and a right side surface of the handle housing 30d4, and may be formed by partially protruding each of the left side and right side surfaces thereof toward the outer wall 30d3.

The protruding surface portion 30d46 may be formed on an upper surface of the handle housing 30d4, and may be formed by protruding a portion of the upper surface 30d41 thereof downwards.

In one example, as illustrated, a cut-away 30d44 may be defined in a lower surface 30d42 of the handle housing 30d4 to provide a movement path of the pivot link 353 of the handle driver 35.

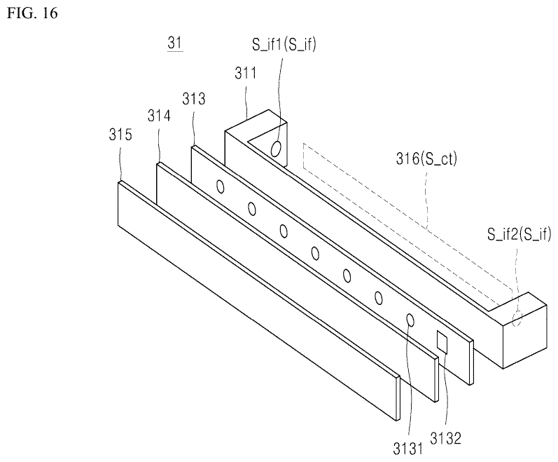

FIG. 16 illustrates a detailed structure of the pop-up handle 31 disposed in front of the first handle body 311 as described above.

Referring to FIG. 16, the pop-up handle 31 provided in the dish washer 1 may further include a handle substrate 313 that is disposed on a front surface of the first handle body 311 and has at least one light-source element 3131 mounted thereon, a light-guide plate 314 that is disposed in front of the handle substrate 313 and diffuses visible light generated from the light-source element 3131, and the decoration panel 315 that is disposed in front of the light-guide plate 314.

The light-source element 3131 generates visible light or another type of light when the pop-up handle 31 moves, thereby visually notifying the user that the pop-up handle 31 is operating normally.

The light-source element 3131 may be applied without limitation in terms of the type thereof as the light-source element 3131 may receive power and generate predetermined visible light. In one example, the light-source element 3131 may be an LED (light emitting diode) element.

The following description will be based on an example in which the LED element is applied as the light-source element 3131. However, embodiments of the present disclosure are not limited thereto.

FIG. 16 illustrates a configuration in which a total of 7 LED elements are mounted on the handle substrate 313. However, embodiments of the present disclosure are not limited thereto, and the number of LED elements may be increased or decreased depending on a size and a shape of the first handle body 311.

In one example, the light-guide plate 314 serves to diffuse the visible light generated from the light-source element 3131.

More specifically, the visible light generated from the light-source element 3131 may be introduced into the light-guide plate 314 through a rear surface of the light-guide plate 314. Then, the visible light received inside the light-guide plate 314 may be spread therein such that the visible light diffuses toward an edge of the light-guide plate 314.

In some examples, the decoration panel 315 disposed in front of the light-guide plate 314 may be surface-treated to have the same texture as that of the front panel 30a of the door 30 as described above.

Therefore, the visible light introduced into the light-guide plate 314 may not pass through the decoration panel 315 and may be projected to the outside through the edge of the light-guide plate 314.

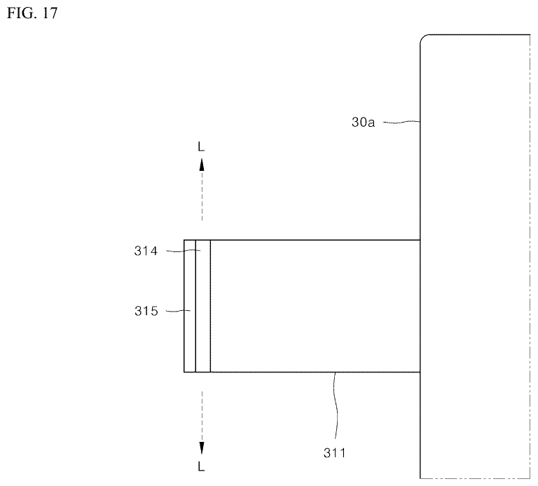

In order to project the visible light, the edge of the light-guide plate 314 may be exposed to the outside, as shown in FIG. 17.

That is, the light-guide plate 314 may be positioned so as to be sandwiched between the decoration panel 315 and the front surface of the first handle body 311, while the edge of the light-guide plate 314 may not be covered with the decoration panel 315 and the front surface of the first handle body 311.

Therefore, as illustrated, the light generated from the light-source element 3131 may travel through the inside of the light-guide plate 314 and then through the edge of the light-guide plate 314 and then may be effectively projected to the outside. Thus, the user may effectively identify an operating state of the pop-up handle 31 based on the optical light projected through the edge of the light-guide plate 314.

Furthermore, since the visible light is projected only through the edge of the light-guide plate 314, a lighting effect similar to indirect lighting may be achieved, thereby improving aesthetic sensibility for the user.

In one example, the pop-up handle 31 of the present disclosure is configured to automatically move forwards and automatically move backwards according to the operation of the handle driver 35.

Therefore, during the automatic backward movement of the pop-up handle 31, there is a possibility that the hand of the user or an object may be caught into between the first handle body 311 and the door 30. Therefore, the dish washer 1 may include a structure for providing a warning of an event where a hand is caught during the operation of the handle to the user to thereby prevent the hand from being caught.

In some implementations, a vibration element 3132 can provided in the pop-up handle 31 to provide a warning for a hand being caught.

For example, the vibration element 3132 may be mounted on the handle substrate 313 and may be configured to generate a haptic vibration in the pop-up handle 31 when the hand being caught is detected.

As shown in FIG. 16, the vibration element 3132 may be mounted on the handle substrate 313.

In some examples, either a piezo element or a haptic motor may be selected as the vibration element 3132 that may generate the haptic vibration and may be effectively mounted on the handle substrate 313.

In some examples, the pop-up handle 31 may further include a detector for detecting the hand being caught.

As will be described later, the detectors for detecting the hand being caught may be referred to as a first safety sensor S_f1 and a second safety sensor S_f2.

The first safety sensor S_f1 detects whether the hand of the user is caught with into between the first handle body 311 and the door 30.

In one example, the first safety sensor S_f1 may include either a touch sensor S_ct or an infrared sensor S_if.

The touch sensor S_ct may be a capacitive touch sensor. In this case, a conductive sheet 316 constituting the capacitive touch sensor may be disposed on a rear surface of the first handle body 311 facing the door 30 so that contact of the user's finger therewith may be effectively detected by the sensor.

The infrared sensor S_if may be configured to project infrared rays from a transmitter S_if1 toward a receiver S_if2 and identify presence of the user's finger between the transmitter S_if1 and the receiver S_if2 based on whether the infrared rays are received by the receiver S_if2. In some examples, as illustrated in FIG. 16, the transmitter S_if1 and the receiver S_if2 may be separately and respectively disposed at both opposing ends of the first handle body 311.

However, the positions of the transmitter S_if1 and receiver S_if2 are only examples, and the transmitter S_if1 and receiver S_if2 may be installed in other positions than the positions on the first handle body 311.

The second safety sensor S_f2 detects whether an object other than the hand of the user is located between the pop-up handle 31 and the door 30.

For example, the second safety sensor S_f2 may include one of a strain sensor that detects whether the pop-up handle 31 or the handle driver 35 is deformed when the pop-up handle 31 moves backwards, or a current sensor that detects an overload of the driving motor 351 when the pop-up handle 31 moves backwards.

In some examples, the strain sensor may be attached to the first handle body 311 or the second handle body 312 constituting the pop-up handle 31, or may be attached to the pivot link 353 of the handle driver 35.

In some examples, the current sensor may be provided in a power supply 48 as described below and configured to detect a current value supplied to the driving motor 351 through the power supply 48.

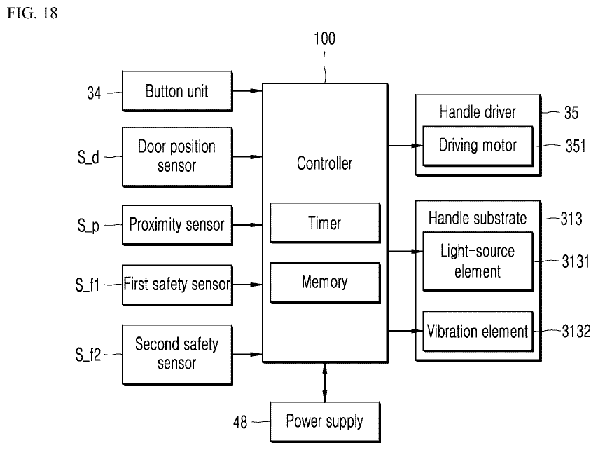

Hereinafter, referring to FIG. 18, the configuration of the controller 100 included in the dish washer 1 will be described.

As shown in FIG. 18, the dish washer 1 may include the controller 100 for controlling each of the functional modules of the dish washer.

For example, the controller 100 may include various forms such as an electric circuit, a computer, a microcontroller, a microcomputer, or a microprocessor.

In some implementations, the controller 100 may be configured to be electrically connected to the driving motor 351 of the handle driver 35. The controller 100 may be configured to start or stop the operation of the driving motor 351 by controlling the power supplied to the driving motor 351 from the power supply 48 as described below.

When the user's intention to open the door 30 is identified as being present using the proximity sensor S_p, the controller 100 may be configured to supply the power to the driving motor 351 of the handle driver 35 through the power supply 48 to drive the driving motor 351 in the forward direction to move the pop-up handle 31 in the frontward direction to the extended position Pd.

Furthermore, when a predetermined waiting time has elapsed after the pop-up handle 31 has moved to the extended position Pd, the controller 100 may be configured to supply the power to the driving motor 351 to drive the driving motor 351 in the reverse direction to move the pop-up handle 31 backward to the retracted position.

In some examples, the predetermined waiting time may be in a range of 2.5 seconds inclusive to 3.5 seconds inclusive.

The above-defined range of the predetermined waiting time may be selected based on a time duration it takes for the user to remove the hand thereof from the pop-up handle 31 after grasping the pop-up handle 31 to open the door 30.

Furthermore, the controller 100 may be configured to be electrically connected to the button unit 34 for inputting a user's manipulation command. When the user's power on-off manipulation input, washing course selection manipulation, or option selection manipulation is input through the button unit 34, the button unit 34 may transmit a corresponding electrical signal thereto to the controller 100.

When the electrical signal has been transmitted from the button unit 34 to the controller, the controller 100 may be configured to turn on/off the power of the dish washer 1 or to control the dish washer 1 to perform an individual cycle of the dish washer 1 according to the selected washing course and the selected operation mode.

In some examples, the user's manipulation command may be input through other input devices such as a user's wireless terminal, etc. in addition to the button unit 34.

Furthermore, the controller 100 may be configured to be electrically connected to the door position sensor S_d. The controller 100 may be configured to determine whether the door 30 is currently closed or opened based on the signal received from the door position sensor S_d, and to identify absence or presence of the user's intention to open the door 30 in a state in which the door 30 is closed, and to operate the handle driver 35 to move the pop-up handle 31 in the frontward direction to the extended position Pd when the door 30 needs to be opened.

Furthermore, the controller 100 may be configured to be electrically connected to the proximity sensor S_p. The controller 100 may be configured to determine whether the user is approaching a position within a specific detection range from door 30 based on the signal received from the proximity sensor S_p.

As described above, the proximity sensor S_p may include one of a radar sensor, an image sensor, or an infrared sensor.

Furthermore, the controller 100 may be electrically connected to the first safety sensor S_f1. As described above, the first safety sensor S_f1 detects whether the hand of the user is caught into between the pop-up handle 31 and the door 30. The controller 100 may determine whether the hand of the user is caught into between the pop-up handle 31 and the door 30 based on a signal received from the first safety sensor S_f1.

As described above, the first safety sensor S_f1 may include either the touch sensor S_ct or the infrared sensor S_if.

Furthermore, the controller 100 may be electrically connected to the second safety sensor. As described above, the second safety sensor detects whether an object other than the hand of the user is present between the pop-up handle 31 and the door 30.

The controller 100 may be configured to determine whether the object is caught into between the pop-up handle 31 and the door 30 based on a signal received from the second safety sensor.

As described above, the second safety sensor may include either the strain sensor that detects whether the pop-up handle 31 or the handle driver 35 is deformed when the pop-up handle 31 moves backwards, or a current sensor that detects an overload of the driving motor 351 when the pop-up handle 31 moves backwards.

Furthermore, the controller 100 may be configured to be electrically connected to the light-source element 3131 and the vibration element 3132 mounted on the handle substrate 313.

The controller 100 may be configured to provide the power to the light-source element 3131 to generate the visible light or other types of light at the same time as a time when the forward movement of the pop-up handle 31 is initiated, or sequentially, thereby visually indicating to the user that the pop-up handle 31 is being operating normally and that the pop-up handle 31 will be moved forwards toward the extended position Pd.

As described above, the light-source element 3131 may be embodied as the LED element that may receive the power to emit predetermined visible light.

Furthermore, when the controller 100 determines that the hand of the user or an object is caught into between the pop-up handle 31 and the door 30 after the backward movement of the pop-up handle 31 has begun, based on the output signal received from the first safety sensor S_f1 or the second safety sensor, the controller may be configured to supply power to the vibration element 3132 to generate a predetermined haptic vibration to warn the user of the “hand or object being caught”.

As described above, the vibration element 3132 may include either the piezo element or the haptic motor.

As described below, the controller 100 has generated a haptic vibration for the primary warning purpose using the vibration element 3132. However, thereafter, the controller may be configured to detect that the hand of the user is still present between the pop-up handle 31 and the door 30. In this case, the controller 100 may be configured to increase the intensity of the haptic vibration by increasing the intensity of the power supplied to the vibration element 3132.

Furthermore, the controller 100 may be configured to be electrically connected to a sound output unit that generates voice output or sound output.

As will be described below, when the controller 100 detects that the hand of the user or an object is caught into between the pop-up handle 31 and the door 30 based on the signal from the first safety sensor S_f1 or the second safety sensor, the controller 100 may be configured to generate a voice alarm or an acoustic alarm through the sound output unit to instruct the user to remove the hand or object from the pop-up handle 31.

For example, the voice alarm may include guidance information or warning information such as ‘Please remove your hand. I will retract the handle’ or ‘Please remove the object from the handle. I will retract the handle’.

In one example, the controller 100 may be configured to be electrically connected to a memory and a timer. The controller 100 may be configured to retrieve an operation condition and a time condition related to each of the cycles that are pre-stored in the memory for each washing course and to generate a control signal for controlling a progress and an end of the cycle according to the washing course based on the operation condition and the time condition.

Furthermore, as will be described later, information about a first set time duration and information about a second set time duration used for switching the operation of the handle driver 35 may be further stored in the memory.

Furthermore, the controller 100 may be configured to measure an elapsed time of each of the cycles using the timer and determine whether each of the cycles has been completed based on a comparing result of the measured time with the pre-stored time condition related to each of the cycles.

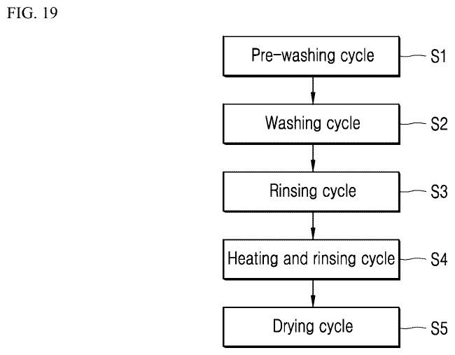

In some examples, the cycles may include a pre-washing cycle S1, a washing cycle S2, a rinsing cycle S3, a heating and rinsing cycle S4, and a drying cycle S5 as shown in FIG. 19.

Hereinafter, a method for controlling the dish washer 1 according to the present disclosure will be described with reference to FIG. 19 to FIG. 22.

As illustrated in FIG. 19, the controller 100 may be configured to generally control progress of the washing course of the dish washer 1 in which the pre-washing cycle S1, the washing cycle S2, the rinsing cycle S3, the heating and rinsing cycle S4, and the drying cycle S5 are executed in this order.

The pre-washing cycle S1 refers to a cycle in which the washing water is circulated under an operation of the washing pump 45 without injecting the detergent through the detergent supply device and an amount of contamination is measured using a turbidity sensor provided in the sump 41. The washing cycle S2 refers to a cycle in which dishes are washed by circulating the washing water while injecting the detergent through the detergent supply device.

Each of the rinsing cycle S3 and the heating and rinsing cycle S4 refers to a cycle in which rinse is injected from the detergent supply device and the washing water is circulated to remove the detergent remaining on the dishes.

During the heating and rinsing cycle S4, the heated washing water is supplied so that the dishes may be heated to a predetermined temperature. Thus, the drying efficiency of the dishes may be improved and the drying time may be shortened in the drying cycle S5 that is performed after the completion of the rinsing cycle S3 and heating and rinsing cycle S4.

The above detailed cycles may be controlled to be omitted or to be combined with each other so as to be performed repeatedly depending on the selected washing course settings and options.

In some examples, a water discharge cycle of the washing water used in each of the cycles and a water supply cycle that supplies new washing water may be included between temporally adjacent ones of the cycles.

The water supply cycle may be included before the pre-washing cycle S1.

The water discharge cycle and the water supply cycle may be performed between the pre-washing cycle S1 and the washing cycle S2, between the washing cycle S2 and the rinsing cycle S3, and between the heating and rinsing cycle S4 and the rinsing cycle S3. The water discharge cycle may be performed between the heating and rinsing cycle S4 and the drying cycle S5.

The water supply cycle may be performed by controlling an aqua stop device included in the water supply 43 to supply the washing water to the sump 41 through a water supply path. The water discharge cycle may be performed by controlling the water discharger 44 connected to the sump 41 to discharge the washing water to the outside out of the dish washer 1 through a water discharge path.

In some examples, when the user's intention to open the door 30 is identified as being present using the proximity sensor S_p before the washing course that is performed in the above order of the cycles is started or after the washing course has been completed, the controller 100 may be configured to drive the handle driver 35 in the forward direction to drive the pop-up handle 31 to automatically move forwards from the retracted position Pa to the extended position Pd.

Furthermore, after a predetermined waiting time has elapsed after the pop-up handle 31 has moved to the extended position Pd, the controller 100 may be configured to drive the handle driver 35 in the reverse direction, so that the pop-up handle 31 automatically moves backwards from the extended position Pd to the retracted position Pa.

Furthermore, when the user's intention to open the door 30 is additionally identified as being present using an additional detector, the controller 100 may be configured to control the pop-up handle 31 to move forwards from the retracted position Pa toward the extended position Pd even during the washing cycle.

This is to deal with a case where the door 30 is opened while the washing cycle is in progress, for example, in order to add the dishes to be washed into the washing space in the tub.

When the forward movement of the pop-up handle 31 is initiated during the progress of the washing course, the controller 100 may be configured to temporarily stop the progress of the washing course in consideration of water leakage prevention and user safety.

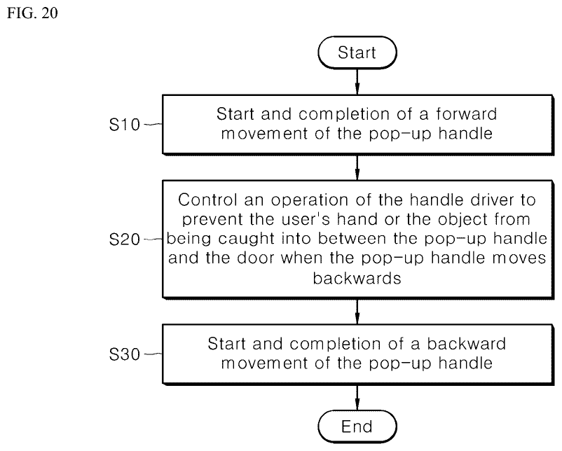

FIG. 20 illustrates an example of a control method of the dish washer 1 according to the present disclosure. The control method includes step S20 of controlling the operation of the handle driver 35 to prevent the hand of the user or the object from being caught into between the pop-up handle 31 and the door 30 when the pop-up handle 31 moves backwards.

As described above, when the controller 100 has identified the user's intention to open the door 30 based on the signal from the proximity sensor S_p before start of the selected washing course and after completion of the selected washing course, the controller may be configured to supply power to the handle driver 35 to operate the handle driver 35 in the forward direction to automatically move the pop-up handle 31 forwardly from the retracted position Pa to the extended position Pd and perform completing the forward movement of the handle driver 35 in S10.

The step S20 may be performed after a predetermined waiting time has elapsed after the forward movement of the pop-up handle 31 has been completed in S10.

As described above, the predetermined waiting time may be in a range of 2.5 seconds inclusive to 3.5 seconds inclusive.

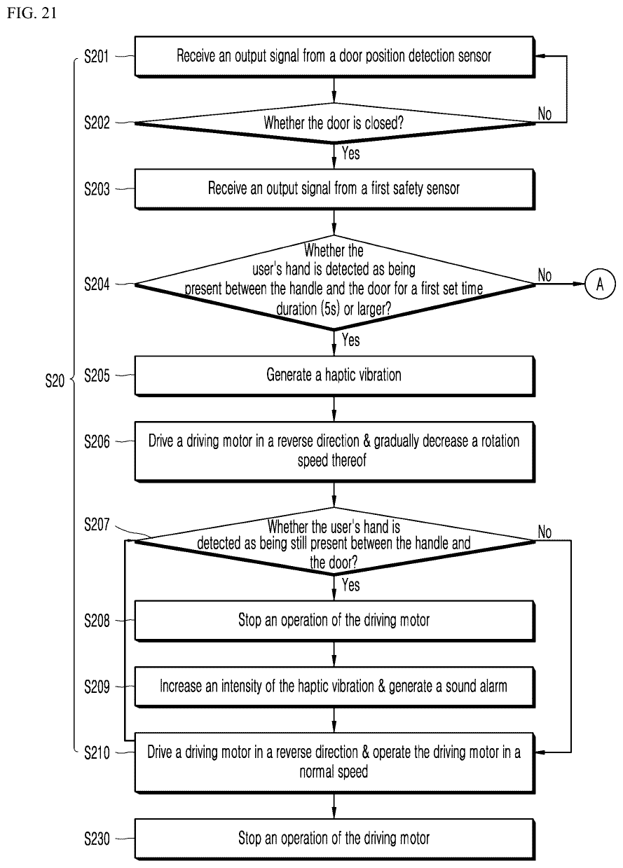

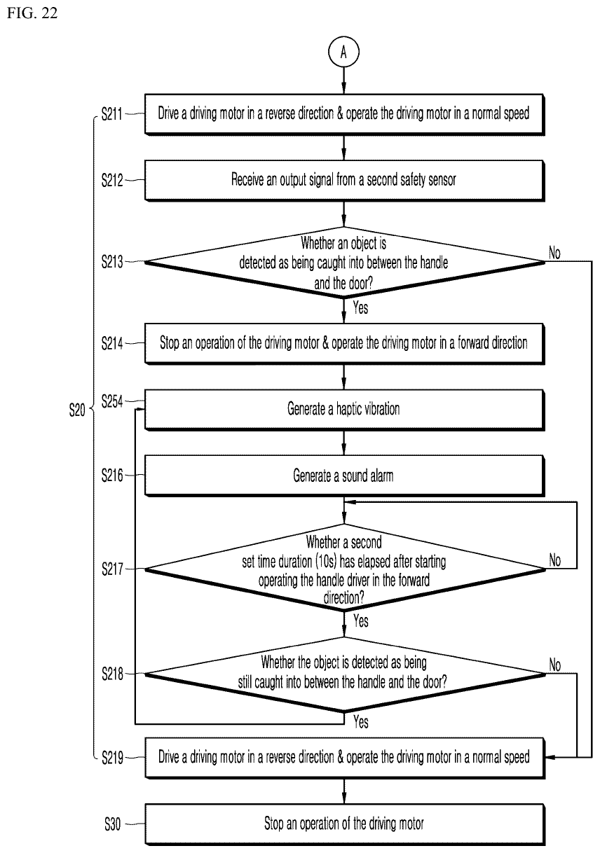

FIG. 21 and FIG. 22 illustrate detailed steps of the step S20.

Referring to FIG. 21, the controller 100 is configured to first receive the output signal from the door position sensor S_d, and determines whether the door 30 is currently closed or opened based on the received output signal of the door position sensor S_d in S201 and S202.

The identifying of whether the door 30 is opened or closed in this way is done in consideration of the fact that upon determination that the door is open, the user may close the door 30 using the pop-up handle 31. That is, after the user closes the door 30 using the pop-up handle 31, the backward movement of the pop-up handle 31 may be initiated.

When, in step S202, the door 30 is identified as being currently closed, the controller 100 is configured to receive the output signal from the first safety sensor S_f1 in S203.

The first safety sensor S_f1 may include either the touch sensor S_ct or the infrared sensor S_if.

When the output signal has been received from the first safety sensor S_f1 in step S203, the controller 100 is configured to determine whether the hand of the user is detected as being present between the pop-up handle 31 and the door 30 for the first set time duration or larger based on the received output signal of the first safety sensor S_f1 in S204.

For example, the first set time duration may be in a range of 0.4 seconds inclusive to 0.6 seconds inclusive. In some implementations, the first set time duration may be 0.5 seconds.

In some examples, identifying whether the hand of the user is continuously detected for the first set time duration or larger even when the hand of the user is detected to be caught into between the pop-up handle 31 and the door 30 based on the signal from the first safety sensor S_f1 is done in consideration of the fact that a temporary touch motion of the user may occur and the user may take an action to immediately remove the hand from the pop-up handle 31.

When it is determined that the hand of the user is detected as being present between the pop-up handle 31 and the door 30 for the first set time duration or larger based on the output signal of the first safety sensor S_f1 in step S204, the controller 100 is configured to supply the power to the vibration element 3132 to operate the vibration element 3132 to generate the haptic vibration in the pop-up handle 31 in S205.

This haptic vibration may be a first haptic vibration alarm to notify that the backward movement of the pop-up handle 31 will begin immediately and, consequently, injury to the hand of the user may occur.

When the first haptic vibration alarm has been generated in step S205, the controller 100 may be configured to supply power to the driving motor 351 to drive the driving motor 351 in the reverse direction to initiate the backward movement of the pop-up handle 31 in S206.

In some examples, the controller 100 may be configured to adjust the power to be supplied to the driving motor 351 so that the driving motor 351 drives at a normal speed when the operation of the pop-up handle 31 starts, but after the operation thereof starts, the rotation speed of driving motor 351 is gradually decreased.

The rotation speed of the driving motor 351 is decreased in this way, such that a backward movement speed of the pop-up handle 31 may be reduced, and thus, a possibility of injury to the hand of the user may be further reduced.

When the backward movement of the pop-up handle 31 starts in step S206, the controller 100 is configured to determine whether the hand of the user is continuously detected as being present between the pop-up handle 31 and the door 30 based on the output signal of the first safety sensor S_f1 in S207.

When it is determined in step S207 that the hand of the user is still detected as being present between the pop-up handle 31 and the door 30 based on the output signal of the first safety sensor S_f1 after the backward movement of the pop-up handle 31 has been initiated, the controller 100 is configured to cut off the power being supplied to the driving motor 351 of the handle driver 35 to stop the operation of the driving motor 351 and thus stop the backward movement of the pop-up handle 31 for the user's safety and injury prevention in S208.

When the backward movement of the pop-up handle 31 is stopped in step S208, the controller 100 is configured to increases an intensity of the power being supplied to the vibration element 3132 to increase an intensity of the haptic vibration of the pop-up handle 31 and is further configured to generate the voice alarm through the sound output unit in S209.

In some examples, the increased intensity haptic vibration may be a secondary haptic vibration alarm to warn that the hand of the user is in a dangerous state.

Furthermore, the voice alarm may include information that informs that the hand of the user is in a dangerous state, such as, for example, ‘Please take your hand off. I will retract the handle.’.

When the secondary haptic vibration alarm and the voice alarm have been generated in step S209, the control method of the controller 100 may proceed to step S207 as described above in which the controller 100 may be configured to determine whether the hand of the user is still detected as being present between the pop-up handle 31 and the door 30.

In some examples, when it is determined in step S207 that the hand of the user is not detected as being present between the pop-up handle 31 and the door 30 after the backward movement of the pop-up handle 31 has been initiated, it is determined that the hand of the user has been currently removed from the pop-up handle 31 and thus the dangerous state is resolved. In response to this determination, the controller 100 may be configured to supply a normal power to the driving motor 351 so that the driving motor 351 drives in the reverse direction at a normal speed S210.

Accordingly, the pop-up handle 31 may continue to move in the backward direction at a normal speed.

When the backward movement of the pop-up handle 31 continues such that the backward movement of the pop-up handle 31 to the retracted position Pa has been completed, the controller 100 may be configured to cut off the power being supplied to the driving motor 351 to stop the operation of the handle driver 35 to terminate the backward movement of the pop-up handle 31 in S30.

In one example, when it is determined in step S204 that the hand of the user is not detected as being present between the pop-up handle 31 and the door 30 for the first set time duration or larger based on the output signal of the first safety sensor S_f1, the controller 100 may be configured to determine that the user's safety is secured and thus to supply the power to the driving motor 351 to drive the driving motor 351 in the reverse direction to initiate the backward movement of the pop-up handle 31 in S211.

In this case, the controller 100 may be configured to supply the normal power to the driving motor 351 so that the driving motor 351 drives at a normal speed to move the pop-up handle 31 backwards at a normal speed.

When the backward movement of the pop-up handle 31 has been initiated in step S211, the controller 100 is configured to receive the output signal from the second safety sensor and to determine whether an object is caught into between the pop-up handle 31 and the door 30 based on the received output signal of the second safety sensor in S212 and S213.

As described above, the second safety sensor may include one of a strain sensor that detects whether the pop-up handle 31 or the handle driver 35 is deformed when the pop-up handle 31 moves backwards, or a current sensor that detects an overload of the driving motor 351 when the pop-up handle 31 moves backwards.

When the object has been detected as being present between the pop-up handle 31 and the door 30 in step S213, the controller 100 is configured to cut off the power being supplied to the driving motor 351 to stop the driving motor 351 in order to prevent damage to the pop-up handle 31 or the handle driver 35 due to the object being caught into between the pop-up handle 31 and the door 30, and then, to immediately re-supply the power so that the driving motor 351 may drive in the forward direction in S214.

Thus, the pop-up handle 31 may move forwards again toward the extended position Pd, such that damage to or breakage of the pop-up handle 31 and the handle driver 35 due to the object being caught into between the pop-up handle 31 and the door 30 may be minimized.

In one example, after the forward movement of the pop-up handle 31 has been initiated in step S214, the controller 100 is configured to supply the power to the vibration element 3132 to operate the vibration element 3132 to generate the haptic vibration in the pop-up handle 31 in S215.

After the haptic vibration has been generated in step S215 or at the same time as a time when the haptic vibration has been generated in step S215, the controller 100 is configured to generate the voice alarm through the sound output unit in S216.

In some examples, the voice alarm may include information such as, for example, “Please remove the object from the handle. I will retract the handle.” This is because while the object is caught into between the pop-up handle 31 and the door 30, the pop-up handle 31 may not move backwards.

After the voice alarm has been generated in step S216, the controller 100 is configured to determine whether an elapsed time duration after the driving motor 351 drives in the forward direction is greater than or equal to the predetermined second set time duration using a timer in S217.

In some examples, the second set time duration may be in a range of 9 seconds inclusive to 11 seconds inclusive. For instance, the second set time duration may be 10 seconds.

In some examples, the second set time duration may be set in consideration of a time duration taken for the user to recognize the object being caught into therebetween through the voice alarm, etc. and then, to remove the caught object from the pop-up handle 31.

When it is determined in step S217 that the elapsed time duration after the driving motor 351 drives in the forward direction is greater than the predetermined second set time duration, the controller 100 determines whether the object is re-detected as being present between the pop-up handle 31 and the door 30 based on the output signal received from the second safety sensor in S218.

Upon determination that the object is re-detected as being present between the pop-up handle 31 and the door 30 in step S218, the control method of the controller may return to step S215 as described above in which the controller 100 may be configured to repeat the subsequent steps thereto.

In one example, upon determination that the object is not re-detected as being present between the pop-up handle 31 and the door 30 in step S218, that is, when it is determined that the object has been removed from the handle 31, the controller 100 is configured to supply the normal power to the driving motor 351 so that the driving motor 351 drives in the reverse direction at a normal speed in S219.

Accordingly, the pop-up handle 31 may start moving backwards from the extended position Pd at a normal speed.

When the backward driving of the pop-up handle 31 continues in this manner such that the backward movement of the pop-up handle 31 to the retracted position Pa has been completed, the controller 100 may be configured to cut off the power being supplied to the driving motor 351 to stop the operation of the handle driver 35 to terminate the backward movement of the pop-up handle 31 in S30.

Although the embodiments of the present disclosure have been described in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A dish washer comprising:
a tub that defines a washing space configured to accommodate one or more objects to be washed therein, the tub having an open front surface that is in fluid communication with the washing space;
a door configured to open and close the open front surface of the tub;
a handle configured to reciprocate between (i) an extended position in a forward direction relative to the door and (ii) a retracted position in which the handle is at least partially accommodated within the door; and
a handle driver disposed within the door and configured to move the handle from the retracted position toward the extended position or from the extended position toward the retracted position,
wherein the handle driver comprises:
a pivot link having (i) a first end configured to rotate relative to the door and (ii) a second end that is connected to the handle and configured to rotate relative to the handle,
a driving cam configured to (i) press the pivot link in a frontward direction based on the driving cam rotating in a first direction and (ii) press the pivot link in a rearward direction based on the driving cam rotating in a second direction opposite to the first direction, and
a driving motor configured to generate a driving force for rotating the driving cam in the first direction or the second direction, the driving motor comprising a rotation shaft disposed below a vertical level of the handle.

2. The dish washer of claim 1, wherein the door is configured to pivot about a pivot axis relative to the tub to thereby open and close the open front surface of the tub, and
wherein a rotation direction of the door around the pivot axis to open the tub matches one of the first direction or the second direction of the drive motor to move the handle toward the extended position.

3. The dish washer of claim 1, wherein the driving cam comprises:
a cam body configured to rotate based on the driving force of the driving motor; and
a driving pin that protrudes from one side surface of the cam body toward the pivot link,
wherein the pivot link defines a guide groove between the first end and the second end and, the guide groove receiving the driving pin, and
wherein the driving pin is configured to, based on the cam body rotating in the first or second direction, move relative to and along the guide groove to thereby cause the pivot link to pivot in the frontward or rearward direction.

4. The dish washer of claim 3, wherein the driving pin is located at a position that defines, in a state in which the handle is located at the extended position, a predetermined intersection angle between (i) a virtual first extension line extending from a rotation center of the cam body to a center of the driving pin and (ii) a virtual second extension line that is parallel to a movement direction of the handle to the extended position and extends through the rotation center of the cam body.

5. The dish washer of claim 4, wherein the predetermined intersection angle is less than or equal to 5 degrees.

6. The dish washer of claim 1, further comprising a handle housing disposed inside the door and configured to receive the handle therein based on the handle moving to the retracted position,
wherein the handle housing defines a rail groove configured to guide a reciprocating movement of the handle between the extended position and the retracted position.

7. The dish washer of claim 6, wherein the handle comprises a guide protrusion that protrudes toward the rail groove and is inserted into the rail groove, and
wherein the guide protrusion is configured to move along the rail groove during the reciprocating movement of the handle.

8. The dish washer of claim 1, wherein the door defines an opening at a front surface thereof, and
wherein the handle is configured to reciprocate through the opening of the door during a reciprocating movement of the handle and configured to close the opening of the door based on the handle being disposed at the retracted position.

9. The dish washer of claim 8, wherein the opening is spaced apart from a top surface of the door by a vertical distance, and
wherein the opening is spaced apart from each of right and left side surfaces of the door by a left-right distance that is less than the vertical distance.

10. The dish washer of claim 8, wherein the handle has a front end surface that is configured to be coplanar with the front surface of the door based on the handle being disposed at the retracted position.

11. The dish washer of claim 1, wherein the handle comprises:
a first handle body configured to be exposed out of the door based on the handle moving to the extended position; and
a second handle body connected to a rear end of the first handle body and received inside the door.

12. The dish washer of claim 11, wherein a vertical width of the second handle body is greater than a vertical width of the first handle body.

13. The dish washer of claim 12, wherein a front surface of the second handle body is configured to, based on the handle being disposed at the extended position, be disposed at a front surface of the door or rearward relative to the front surface of the door.

14. The dish washer of claim 1, further comprising a controller configured to determine whether to move the handle driver and to control power to be supplied to the handle driver,
wherein the controller is configured to control an operation of the handle driver to prevent an object or a hand of a user from being caught between the handle and the door while the handle moves from the extended position to the retracted position.

15. The dish washer of claim 14, further comprising a first safety sensor configured to detect whether the hand of the user is present between the handle and the door,
wherein the controller configured to:
based on an output signal received from the first safety sensor, determine whether the hand of the user is present between the handle and the door for a first set time duration or longer; and
based on a determination that the hand of the user is present between the handle and the door for a time duration greater than the first set time duration, initiate the operation of the handle driver to move the handle backwards toward the retracted position and decrease a movement speed of the handle after the operation of the handle driver has been initiated.

16. The dish washer of claim 15, wherein the first safety sensor comprises a capacitive touch sensor or an infrared sensor.

17. The dish washer of claim 15, further comprising a vibration element disposed at the handle and configured to generate a haptic vibration,
wherein the controller is configured to turn on the vibration element to generate the haptic vibration based on the determination that the hand of the user is present between the handle and the door for the time duration greater than the first set time duration.

18. The dish washer of claim 15, wherein the controller is configured to:
after decreasing the movement speed of the handle, re-determine whether the hand of the user is still present between the handle and the door based on the output signal received from the first safety sensor.

19. The dish washer of claim 18, wherein the controller is further configured to:
based on a determination that the hand of the user is still present between the handle and the door, stop the operation of the handle driver to stop a movement of the handle toward the retracted position.

20. The dish washer of claim 15, further comprising a second safety sensor configured to detect whether the object or the hand of the user is present between the handle and the door,
wherein the controller is further configured to:
based on the output signal received from the first safety sensor, determine that the hand of the user is absent between the handle and the door for a time duration greater than the first set time duration;
based on a determination that the hand of the user is absent between the handle and the door for the time duration greater than the first set time duration, initiate the operation of the handle driver to move the handle backwards;
after the operation of the handle driver has been initiated, determine whether the object or the hand of the user is present between the handle and the door based on an output signal received from the second safety sensor;
based on determination that the object or the hand of the user is present between the handle and the door, stop the operation of the handle driver to stop a movement of the handle toward the retracted position; and
after the handle has stopped, start an operation of the handle driver to move the handle forwards toward the extended position.

21. The dish washer of claim 20, wherein the second safety sensor comprises a strain sensor disposed on the handle or the handle driver, or a current sensor configured to detect electric current supplied to the handle driver.

22. The dish washer of claim 17, wherein the controller is further configured to:
determine whether a second set time duration has elapsed after starting the operation of the handle driver to move the handle forwards toward the extended position;
based on a determination that the second set time duration has elapsed, re-determine whether the object or the hand of the user is present between the handle and the door based on the output signal received from the second safety sensor; and
based on a determination that the object or the hand of the user is absent between the handle and the door, operate the handle driver to move the handle backwards toward the retracted position.
